(19) United States
(12) Patent Application Publication
(10) Pub. No.: US 2013/0029595 A1
(43) Pub. Date: Jan. 31, 2013

(54) COMMUNICATIONS RELATED TO ELECTRIC VEHICLE WIRED AND WIRELESS CHARGING

(71) Applicants: Hanspeter Widmer, Wohlenschwil (CH); Nigel P. Cook, El Cajon, CA (US)

(72) Inventors: Hanspeter Widmer, Wohlenschwil (CH); Nigel P. Cook, El Cajon, CA (US)

(73) Assignee: QUALCOMM Incorporated, San Diego, CA (US)

(21) Appl. No.: 13/557,877

(22) Filed: Jul. 25, 2012

Related U.S. Application Data
(60) Provisional application No. 61/513,524, filed on Jul. 29, 2011.

(51) Int. Cl. H04B 7/24; H02J 17/00

(52) U.S. Cl. 455/39

(57) ABSTRACT

Systems, methods and apparatus are disclosed for wireless power transfer and data transfer. In one aspect a power transmission apparatus is provided. The power transmission apparatus includes a transmitter configured to wirelessly transmit power via a wireless power transfer field at a level sufficient to power or charge an electric vehicle. The power transmission apparatus further includes a controller circuit configured to establish a first wireless communication link with the electric vehicle. The controller circuit is further configured to establish a second wireless communication link with the electric vehicle in response to detecting that the electric vehicle is being charged.

### CROSS REFERENCE TO RELATED APPLICATIONS

This application claims benefit under 35 U.S.C. §119(e) to U.S. Provisional Patent Application No. 61/513,524 entitled “COMMUNICATIONS RELATED TO ELECTRIC VEHICLE WIRED AND WIRELESS CHARGING” filed on Jul. 29, 2011, the disclosure of which is hereby incorporated by reference in its entirety.

### FIELD

The present application relates generally to wireless power transfer and data transfer.

### BACKGROUND

Remote systems, such as vehicles, have been introduced that include locomotion power derived from electricity received from an energy storage device such as a battery. For example, hybrid electric vehicles include on-board chargers that use power from vehicle braking and traditional motors to charge the vehicles. Vehicles that are solely electric generally receive the electricity for charging the batteries from other sources. Battery electric vehicles (electric vehicles) are often proposed to be charged through some type of wired alternating current (AC) such as household or commercial AC supply sources. The wired charging connections require cables or other similar connectors that are physically connected to a power supply. Cables and similar connectors may sometimes be inconvenient or cumbersome and have other drawbacks. Wireless charging systems that are capable of transferring power in free space (e.g., via a wireless field) to be used to charge electric vehicles may overcome some of the deficiencies of wired charging solutions. users of vehicles may access digital content within their vehicles by using such integrated or standalone devices such as onboard computers, DVD players, MP3 players, and portable computers. These devices receive and store content either before being brought into the vehicle, or by accessing a mobile communication network, e.g., a 3G network.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the subject matter described in the disclosure provides a power transmission apparatus. The power transmission apparatus includes a transmitter configured to wirelessly transmit power via a wireless power transfer field at a level sufficient to power or charge an electric vehicle. The power transmission apparatus further includes a controller circuit configured to establish a first wireless communication link with the electric vehicle. The controller circuit is further configured to establish a second wireless communication link with the electric vehicle in response to detecting that the electric vehicle is being charged.

Another aspect of the subject matter described in the disclosure provides an implementation of a method of wireless power transmission. The method includes wirelessly transmitting power via a wireless power transfer field at a level sufficient to power or charge an electric vehicle. The method further includes establishing a first wireless communication link with the electric vehicle. The method further includes establishing a second wireless communication link with the electric vehicle in response to detecting that the electric vehicle is being charged.

Yet another aspect of the subject matter described in the disclosure provides a power transmission apparatus. The power transmission apparatus includes means for wirelessly transmitting power via a wireless power transfer field at a level sufficient to power or charge an electric vehicle. The power transmission apparatus further includes means for establishing a first wireless communication link with the electric vehicle. The power transmission apparatus further includes means for establishing a second wireless communication link with the electric vehicle in response to detecting that the electric vehicle is being charged.

Another aspect of the subject matter described in the disclosure provides an apparatus for wirelessly receiving power. The apparatus includes a receiver configured to wirelessly receive power via a wireless power transfer field from a wireless charging device and to power or charge an electric vehicle based on the wirelessly received power. The apparatus further includes a controller circuit configured to establish a first wireless communication link with the wireless charging device. The controller circuit is further configured to establish a second wireless communication link with the wireless charging device in response an indication that the receiver has started to power or charge the electric vehicle.

### BRIEF DESCRIPTION OF THE DRAWINGS

FIG. 1 shows a block diagram of an exemplary wireless power transfer system, in accordance with exemplary embodiments of the invention.

FIG. 2 shows a schematic diagram of an exemplary wireless power transfer system, in accordance with exemplary embodiments of the invention.

FIG. 3 shows a schematic diagram of a loop antenna, in accordance with exemplary embodiments of the invention.

FIG. 4 shows an exemplary wireless charging system for wirelessly transferring energy and content to and from an electric vehicle, in accordance with exemplary embodiments of the invention.

FIG. 5 shows a side view of an exemplary functional block diagram of the electrical vehicle 412 of FIG. 4, in accordance with exemplary embodiments of the invention.

FIG. 6 shows a functional block diagram of an exemplary charging and communication system that may communicate with external infrastructure, in accordance with exemplary embodiments of the invention.

FIG. 7 shows a functional block diagram of an exemplary electric vehicle system in an electric vehicle, in accordance with exemplary embodiments of the invention.

FIG. 8 shows a diagram of an exemplary embodiment of a charging and communication system coupled with vehicle charging and communication system, in accordance with exemplary embodiments of the invention.

FIGS. 9A and 9B show a functional block diagram of exemplary charging systems, in accordance with exemplary embodiments of the invention.

FIG. 10 shows another functional block diagram of an exemplary charging system in a parking lot, in accordance with exemplary embodiments of the invention.

FIG. 11 shows another functional block diagram of an exemplary charging system that may be installed in a residence, in accordance with exemplary embodiments of the invention.

FIGS. 12A and 12B show functional block diagrams of other exemplary charging systems, in accordance with exemplary embodiments of the invention.

FIG. 13A is a flowchart of an exemplary method for wireless charging an electric vehicle and exchanging content with the electric vehicle, in accordance with exemplary embodiments of the invention.

FIG. 13B is a flowchart of an exemplary method for wireless receiving power and exchanging content with a charging and communication system, in accordance with exemplary embodiments of the invention.

FIG. 14 shows an exemplary graphical user interface 1400 for configuring user accounts, in accordance with exemplary embodiments of the invention.

FIG. 15 shows various exemplary content data structures associated with either charging and communication system or vehicle charging and communication system, in accordance with exemplary embodiments of the invention.

FIG. 16 is a flow chart of an exemplary method performed by the charging and communication system for transferring energy and content, in accordance with exemplary embodiments of the invention.

FIG. 17 shows a flowchart of an exemplary method performed by the vehicle charging and communication system for wirelessly transferring at least one of content and energy, in accordance with exemplary embodiments of the invention.

FIG. 18 shows a flowchart of an exemplary method of transferring content with a charging and communication system, in accordance with exemplary embodiments of the invention.

FIG. 19 shows a flowchart of an exemplary method implemented by a wireless power and communication apparatus, in accordance with exemplary embodiments of the invention.

FIG. 20 illustrates a functional block diagram of a wireless power and communication apparatus, in accordance with exemplary embodiments of the invention.

FIG. 21 is a flowchart of an exemplary method for wirelessly transferring power and content with an electric vehicle, in accordance with exemplary embodiments of the invention.

FIG. 22 illustrates another functional block diagram of a wireless power and communication apparatus, in accordance with exemplary embodiments of the invention.

FIG. 23 is another flowchart of an exemplary method for wirelessly receiving power and content from a charging and communication system, in accordance with exemplary embodiments of the invention.

FIG. 24 illustrates another functional block diagram of a wireless power and communication apparatus, in accordance with exemplary embodiments of the invention.

The various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

Various aspects of implementations within the scope of the appended claims are described below. It should be apparent that the aspects described herein may be implemented in a wide variety of forms and that any specific structure and/or function described herein is merely illustrative. Based on the present disclosure a person/one having ordinary skill in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

The word “exemplary” is used herein to mean “serving as an example, instance, or illustration.” Any implementation described herein as “exemplary” is not necessarily to be construed as preferred or advantageous over other implementations. The following description is presented to enable any person skilled in the art to make and use the invention. The present invention is not intended to be limited by the implementations shown, but is to be accorded with the widest scope consistent with the principles and features disclosed herein.

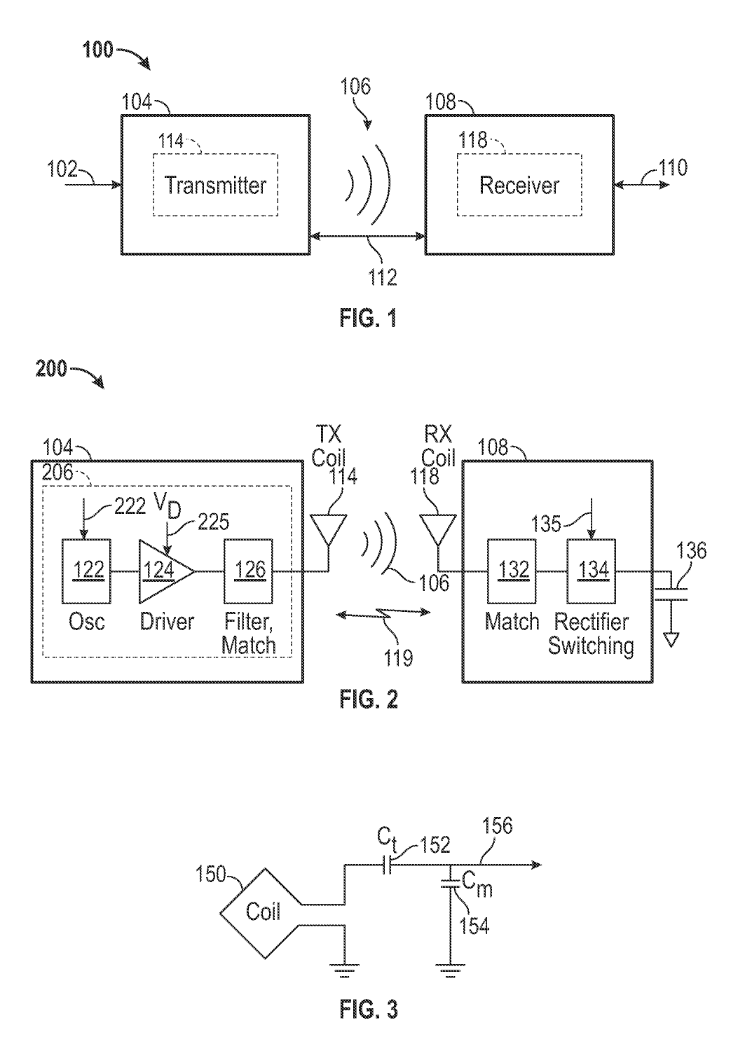

FIG. 1 illustrates a wireless transmission or charging system 100, in accordance with various exemplary embodiments of the present invention. Input power 102 is provided to a transmitter 104 for generating a field (e.g., magnetic) 106 for providing energy transfer. A receiver 108 couples to the field 106 and generates an output power 110 for storing (e.g., charging) or consumption (e.g., powering) by a device (not shown) connected to the output power 110. Both the transmitter 104 and the receiver 108 are separated by a distance 112. In one exemplary embodiment, transmitter 104 and receiver 108 are configured according to a mutual resonant relationship and when the resonant frequency of receiver 108 and the resonant frequency of transmitter 104 are exactly or substantially the same, transmission losses between the transmitter 104 and the receiver 108 are minimal when the receiver 108 is located in the “near-field” of the field 106.

Transmitter 104 further includes a transmit antenna 114 for energy transmission and receiver 108 further includes a receive antenna 118 for energy reception. The transmit and receive antennas 114 and 118 are sized according to applications and devices to be associated therewith. As stated, an efficient energy transfer occurs by coupling a large portion of the energy in the near-field of the transmitting antenna to a receiving antenna rather than propagating most of the energy in an electromagnetic wave to the far field. When in this near-field, a coupling mode may be developed between the transmit antenna 114 and the receive antenna 118. The area around the antennas 114 and 118 where this near-field coupling may occur is referred to herein as a coupling-mode region.

FIG. 2 shows a schematic diagram of a wireless power transfer system. The transmitter 104 includes an oscillator 122, a power amplifier 124, and a filter and matching circuit 126. The oscillator is configured to generate a signal at a desired frequency, such as 468.75 KHz, 6.78 MHz or 13.56 MHz, which may be adjusted in response to adjustment signal 123. The oscillator signal may be amplified by the power amplifier 124 with an amplification amount responsive to control signal 125. The filter and matching circuit 126 may be included to filter out harmonics or other unwanted frequencies and match the impedance of the transmitter 104 to the transmit antenna 114. As a result of driving the transmit antenna 114, the transmitter 104 may wirelessly output power at a level sufficient for charging or power an electronic device or an electric vehicle. For example, the power level provided wirelessly may be on the order of kilowatts (kW) (e.g., anywhere from 1 kW to 110 kW or higher or lower).

The receiver may include a matching circuit 132 and a rectifier and switching circuit to generate a DC power output to charge a battery 136 as shown in FIG. 2 or power a device coupled to the receiver (not shown). The matching circuit 132 may be included to match the impedance of the receiver 108 to the receive antenna 118.

As illustrated in FIG. 3, antennas used in exemplary embodiments may be configured as a “loop” antenna 150, which may also be referred to herein as a “magnetic” antenna. Loop antennas may be configured to include an air core or a physical core such as a ferrite core. The term “antenna” generally refers to a component that may wirelessly output or receive energy for coupling to another “antenna.” The antenna may also be referred to as a coil of a type that is configured to wirelessly output or receive power. As used herein, an antenna 352 is an example of a “power transfer component” of a type that is configured to wirelessly output and/or receive power. Air core loop antennas may be more tolerable to extraneous physical devices placed in the vicinity of the core. Furthermore, an air core loop antenna allows the placement of other components within the core area. In addition, an air core loop may more readily enable placement of the receive antenna 118 (FIG. 2) within a plane of the transmit antenna 114 (FIG. 2) where the coupled-mode region of the transmit antenna 114 (FIG. 2) may be more powerful. The loop antenna may have a Quality factor (Q-factor) of greater than 1000.

As stated, efficient transfer of energy between the transmitter 104 and receiver 108 occurs during matched or nearly matched resonance between the transmitter 104 and the receiver 108. However, even when resonance between the transmitter 104 and receiver 108 are not matched, energy may be transferred at a lower efficiency. Transfer of energy occurs by coupling energy from the near-field of the transmitting antenna to the receiving antenna residing in the neighborhood where this near-field is established rather than propagating the energy from the transmitting antenna into free space.

The resonant or near resonant frequency of the loop or magnetic antennas is based on the inductance and capacitance. Inductance in a loop antenna is generally the inductance created by the loop, whereas, capacitance is generally added to the loop antenna's inductance to create a resonant structure at a desired resonant frequency. As a non-limiting example, capacitor 152 and capacitor 154 may be added to the antenna to create a resonant circuit that generates resonant signal 156. Accordingly, for larger diameter loop antennas, the size of capacitance needed to induce resonance decreases as the diameter or inductance of the loop increases. Furthermore, as the diameter of the loop or magnetic antenna increases, the efficient energy transfer area of the near-field increases. Of course, other resonant circuits are possible. As another non-limiting example, a capacitor may be placed in parallel between the two terminals of the loop antenna. In addition, those of ordinary skill in the art will recognize that for transmit antennas the resonant signal 156 may be an input to the loop antenna 150.

Exemplary embodiments of the invention include coupling power between two antennas that are in the near-fields of each other. As stated, the near-field is an area around the antenna in which electromagnetic fields exist but may not propagate or radiate away from the antenna. They are typically confined to a volume that is near the physical volume of the antenna. In the exemplary embodiments of the invention, magnetic type antennas such as single and multi-turn loop antennas are used for both transmit (Tx) and receive (Rx) antenna systems since magnetic near-field amplitudes tend to be higher for magnetic type antennas in comparison to the electric near-fields of an electric-type antenna (e.g., a small dipole). This allows for potentially higher coupling between the pair. Furthermore, “electric” antennas (e.g., dipoles and monopoles) or a combination of magnetic and electric antennas is also contemplated.

The Tx antenna can be operated at a frequency that is low enough and with an antenna size that is large enough to achieve good coupling (e.g., >−4 dB) to a small Rx antenna at significantly larger distances than allowed by far field and inductive approaches mentioned earlier. If the Tx antenna is sized correctly, high coupling levels (e.g., −2 to −4 dB) can be achieved when the Rx antenna on a host device is placed within a coupling-mode region (i.e., in the near-field) of the driven Tx loop antenna.

It should be noted that the functions and systems are applicable to variety of communication standards such as CDMA, WCDMA, OFDM etc. Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. In addition

Embodiments of the disclosure are directed to communications, interfaces, data flows and the like between a charging system and an electric vehicle. An electric vehicle is not limited to an automobile, and can include any type of mobile vehicle that derives a portion of its power from an energy storage device, such as a battery. For example, an electric vehicle may include a motorcycle, a cart, a scooter, and the like.

The techniques described herein may be used for various wireless charging systems for transferring energy (e.g., electrical, magnetic, and electromagnetic energy) and content (e.g., digital movies, music, podcasts, emails, advertisements, user data, and the like).

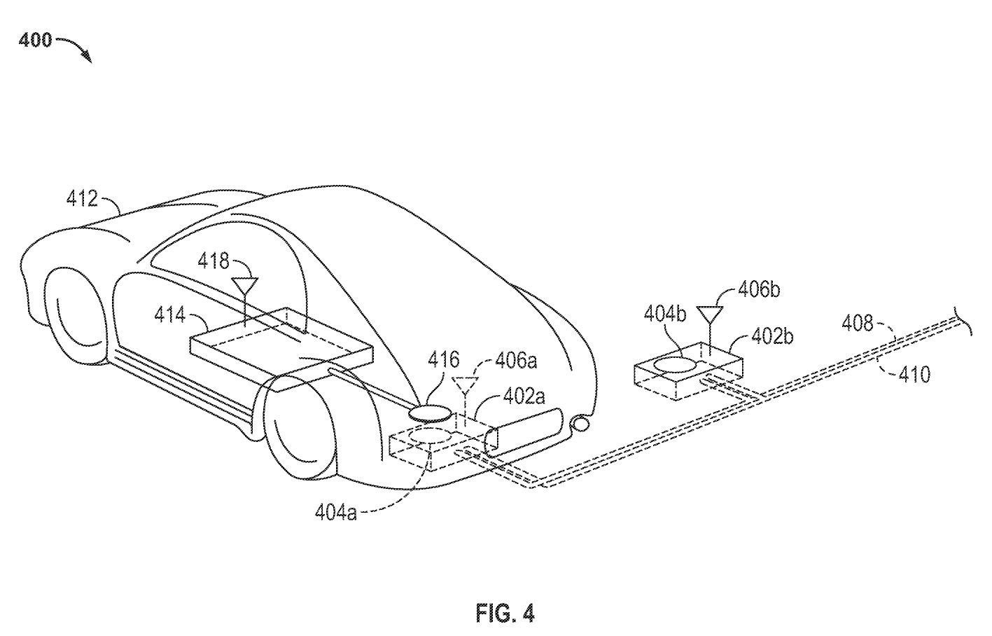

FIG. 4 shows an exemplary wireless charging system 400 for wirelessly transferring energy and content to and from an electric vehicle 412. Energy is provided by power line 410, which carries either alternating current or a direct current. Power line 410 may be a cable or wire having sufficient capacity for supplying the requisite power. The power line 410 may be connected to a power distribution network or grid. Content data is provided by communication line 408, which is connected with a network, such as, the Internet. In some embodiments communication line 408 may be a physical line, such as a wire or cable, connected with a network access device (not shown). However, communication line 408 need not be a physical line. In some embodiments, power line 410 and communication line 408 may separately be wireless links.

As such, systems described herein to the ability to using a device and/or system to control both power transmission and the communication of data/content between a charging and communication system 402a and the electric vehicle 412. The disclosure below describes various method and systems for controlling both power transmission and the communication of data. In one aspect, controlling may include controlling the time and order in which power is transmitted and content is communicated between the charging and communication system 402a and the electric vehicle 412. For example, time division multiple access (TDMA) schemes and other multiple access schemes may be used.

Power line 410 and communication line 408 are both connected with a charging and communication system 402a that includes a power antenna 404a configured to wirelessly transfer energy and a first antenna 406a capable of wirelessly transferring content. It should be appreciated that the charging and communication system 402a may include multiple antennas and functionality for exchanging data using different communication interfaces as will be more fully described below. Charging and communication system 402a may comprise a microcontroller system executing instructions. In some embodiments, power antenna 404a and first antenna 406a may be separate physical antennas. In other embodiments, the power antenna 404a and the first antenna 406a may be the same physical antenna (i.e., logically separate).

In some embodiments, charging and communication system 402a may transmit energy or content to a remote device, such as an electric vehicle 412, via power antenna 404a and first antenna 406a (e.g., energy may be transmitted over the power antenna 404a and content may be transmitted over the first antenna 406a). This capability may be useful for wirelessly charging a battery (not shown) of an electrical vehicle 412, or for wirelessly uploading content to an electric vehicle 412. In other embodiments a second antenna (not shown) may further be provided for data communication as will be described further below.

In some embodiments, charging and communication system 402a may receive energy or content from a remote device (such as the electric vehicle 412) via power antenna 404a and first antenna 406a. The remote device, such as the electric vehicle 412 may additionally wirelessly transfer power and contribute power to the power grid (not shown). Receiving content (e.g., in the form of data related to consumer activities) from the remote device may assist in marketing and advertising.

Wireless charging system 400 may include one or more charging and communication systems 402a and 420b for servicing multiple vehicles at one time. For example, FIG. 1 shows a second charging and communication system 402b, which has power antenna 404b and first antenna 406b. Charging and communication systems 402a and 402b may be identical units, or they may differ in some respects, such as, e.g., power throughput, content bandwidth, electric-vehicle compatibility, communication protocols, or servicing capabilities.

In some embodiments, as illustrated in FIG. 1, the one or more charging and communication systems, such as 402a and 402b, may be configured substantially as panels positioned on the ground with a sufficiently low height that allows an electrical vehicle 412 to be positioned directly over the charging and communication system 402a. However, charging and communication systems 402a and 402b may be located in any such manner that allows wireless transfer of energy and content.

Charging and communication systems 402a and 402b may be installed in a variety of locations. Some suitable locations may be a parking area at a home of the vehicle owner, parking areas reserved for electrical-vehicle wireless charging modeled after petroleum-based filling stations, and parking lots at other locations such as shopping centers and places of employment.

Electric vehicle 412 includes a vehicle charging and communication system 414 that may receive energy and information from the charging and communication system 402a. The vehicle charging and communication system 414 may control power and content transfer with charging and communication system 402a via one or more antennas. Power antenna 416 of electric vehicle 412 may wirelessly transfer energy with power antenna 404a of charging and communication system 402a. Similarly, first antenna 418 may wirelessly transfer content with first antenna 406a of charging and communication system 402a. It should be appreciated that the charging and communication system 402a may include multiple antennas and functionality for exchanging data using different communication interfaces as will be more fully described below. Power antenna 416 and first antenna 418 may be separate physical antennas, or may be the same physical antenna.

FIG. 4 shows the electric vehicle 412 as being positioned over charging and communication system 402a so that the power antenna 416 and first antenna 418 of the electric vehicle 412 couple with the power antenna 404a and first antenna 406a of charging and communication system 402a. In some embodiments, the driver positions the electric vehicle 412 in order to align the power antenna 416 and first antenna 418 with the power antenna 404a and first antenna 406a of the charging and communication system 402a. In some embodiments, the electrical vehicle 412 may provide feedback or automation to properly position the electrical vehicle 412. In some embodiments, the power antenna 416 and first antenna 418 of the electric vehicle 412, or the power antenna 404a and first antenna 406a of the charging and communication system 402a, may include actuators for moving power antenna 404a and power antenna 416 relative to each other, and for moving first antenna 406a and first antenna 418 relative to each other.

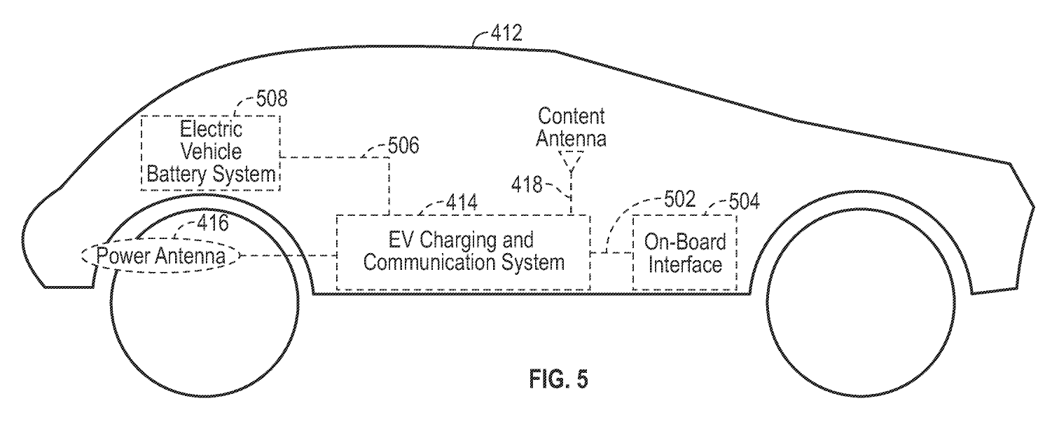

FIG. 5 shows a side view of an exemplary functional block diagram of the electrical vehicle 412 of FIG. 4. As described above with reference to FIG. 4, the electrical vehicle 412 comprises the vehicle charging and communication system 414 having a power antenna 416 and a first antenna 418. Further, the vehicle charging and communication system 414 may be connected via a data link 502 with an on-board interface 504 of the electric vehicle 412. The on-board interface 504 provides access to one or more electronic control units of the electrical vehicle, including, e.g., user interfaces, display devices, data storage devices, engine control units, and battery management units. In some embodiments, the on-board interface 504 may assist in powering the vehicle charging and communication system 414.

Vehicle charging and communication system 414 may also be connected via a power link 506 with an electric vehicle battery system 508. When the power antenna 416 of electric vehicle 412 receives energy from charging and communication system 402a, vehicle charging and communication system 414 may provide the electric vehicle battery system 508 energy for storage (e.g., by charging a battery). When the power antenna 416 of electric vehicle 412 provides energy to a remote system (e.g., charging and communication system 402a), vehicle charging and communication system 414 may drive power antenna 416 by receiving energy from the electric vehicle battery system 508. Because in some embodiments the electric vehicle battery system 508 may provide energy, the electric vehicle battery system 508 may assist in powering the vehicle charging and communication system 414.

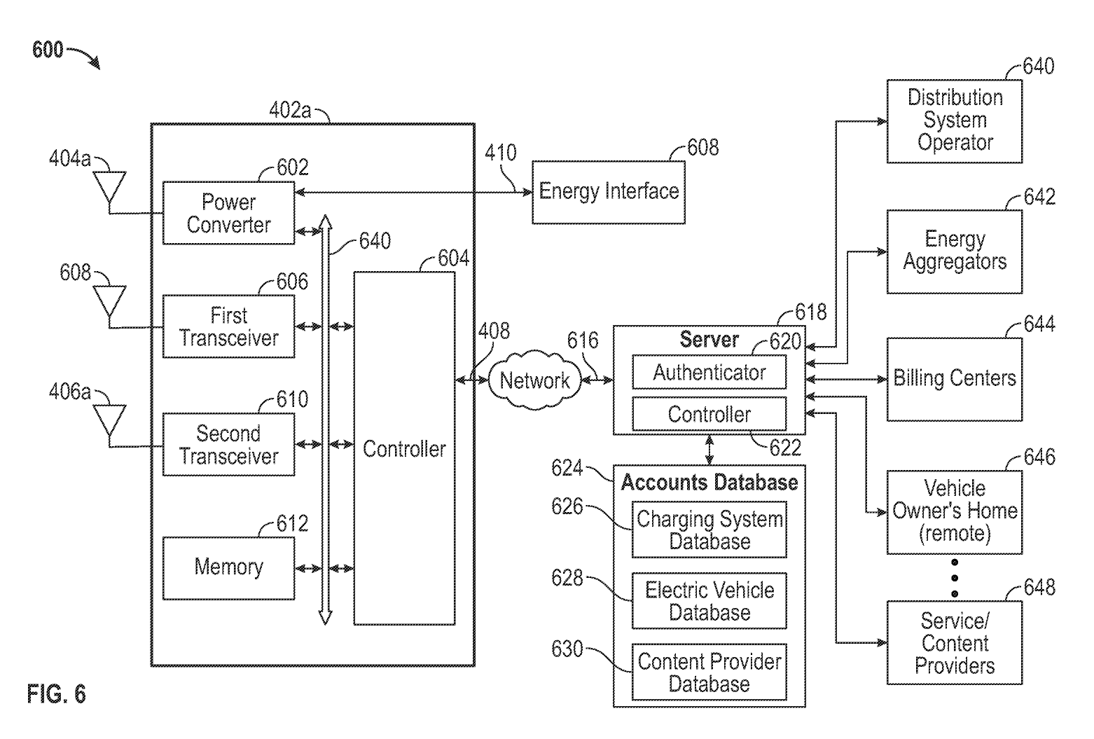

FIG. 6 shows a functional block diagram of an exemplary charging and communication system 402a that may communicate with external infrastructure 600. Charging and communication system 402a may be connected with an energy interface 606 for providing or receiving energy, and with a network 614 for providing or receiving content. The network 614 is further connected with via a server communications interface 616 to a server 618 and with n remote content providers (e.g., service content providers 648).

The charging and communication system 402a includes a controller 604 for coordinating the activities of the charging and communication system 402a. Controller 604 is connected with power converter 602, a first transceiver 606, and a memory 612 by a bus 640. In some embodiments, a second transceiver 610 may be included. However, in some embodiments, these connections may include links (physical or wireless links). In addition, in some embodiments, portions or all of the power converter 602, the first transceiver 606, and the second transceiver 610 may be part of the controller 604.

Power converter 602 is further connected with an energy interface 606 and power antenna 404a. Energy interface 606 provides access to a power supply (not shown), which may be alternating current or direct current. The power supply may be a power grid.

In some embodiments, the energy interface 606 may supply power to power converter 602, which in turn drives power antenna 404a, e.g., at a resonant frequency of power antenna 404a. In some embodiments, the energy interface 606 may receive power from power converter 602. In this case, the power converter 602 receives power from the power antenna 404a and drives the power line 410. In some embodiments, power converter 602 may use the power received by the power antenna 404a to assist in powering the charging and communication system 402a.

Power converter 602 may include an oscillator (not shown), a power amplifier (not shown), a filter (not shown), and a matching circuit (not shown) for driving power antenna 404a. The oscillator may generate a signal at one or more frequencies. The oscillator signal may be amplified by the power amplifier. The filter and matching circuit may be included to filter out harmonics or other unwanted frequencies and to match the impedance of the power converter to power antenna 404a. The power converter 602 may also include a rectifier (not shown) and switching circuitry (not shown) to generate a suitable power output to drive power antenna 404a or power line 410.

First transceiver 606 is connected with first antenna 608. For example, first transceiver 606 may be used for communicating control messages with an electric vehicle 412. Control messages may relate to initialization, synchronization, power modulation, or the like. In some embodiments, the power antenna 404a may be connected with motors (not shown) or other actuation devices capable of translating or rotating power antenna 404a, and with position or orientation sensors. In such embodiments, the first transceiver 606 may be used to receive or transmit control messages concerning the orientation or position of power antenna 404a or of an antenna of a remote device (e.g., power antenna 416 of electric vehicle 412). In some embodiments, power antenna 404a is an antenna array

The second transceiver 610 is further connected with the second antenna 406a. In some embodiments, the first or second transceiver 606 and 610 comprise modules that implement a communication interface for communicating with an electric vehicle 412 or other remote device. For example, the first or second transceivers 606a and 610 may include modules that facilitate far-field communication that is compliant with, e.g., Bluetooth, zigbee, WLAN, DSRC, cellular standards, or the like. In some embodiments, the first or second transceivers 606 and 610 may include modules that facilitate near-field communication that is compliant with, e.g., Near Field Communication standards. In some embodiments, the first and second transceivers 606 and 610 may include coding and encryption modules.

Charging and communication system 402a includes a memory 612 for storing data and the like. In some embodiments, memory 612 provides data storage space for various communication channels (e.g., data storage for power converter 602, power controller 606, and transceiver 610). In some embodiments, memory 612 provides data storage space for storing content data, user data, or program data. In some embodiments, memory 612 may store authentication, authorization, or encryption data. Memory 612 may include solid state devices (such as static and dynamic random access memory devices), hard disk drives, and the like. In other embodiments memory 612 may be a database.

FIG. 6 shows that controller 604 of charging and communication system 402a is further connected with network 614, which may include a WAN (e.g., the Internet) or LAN as described above with reference to FIG. 4. The network 614 may provide access to server 618, which is connected with the accounts database 624. The server 618 may further provide communication between a distribution system operator system 640, energy aggregator systems 642, billing centers 644, a vehicle owner's home system 646, and service/content provider systems 648. In some embodiments, the network 614 may provide connectivity directly between the charging and communication system 402a and the charging system systems 640, 642, 644, 646, and 648.

Server 618 may comprise controller 622 and authenticator 620. The controller 622 of the server 618 may coordinate the activities of the server 618, including, e.g., controlling data access for charging and communication system 402a, accounts database 624, and content providers 632 and 636, and may perform other tasks. Authenticator may create and process authentication data corresponding to, e.g., charging and communication system 402a, electric vehicles 412, and content providers 632.

As described above, the server 618 may also communicate with an accounts database 624. In some embodiments, accounts database 624 may include charging system database 626, electric vehicle database 628, and a content provider database 630. Charging system database 626 may comprise data related to one or more charging and communication systems 402a and 402b. In some embodiments, data of charging system database 626 may include pricing, available services, authentication, authorization data and the like. Electric vehicle database 628 contains user data related to a collection of one or more electrical vehicles. In some embodiments, user data of electric vehicle database 626 may include authentication data, user profiles (including accounts and tasks), and financial information. Content provider database 630 contains data related to one or more charging and communication systems (e.g., 402a and 402b). In some embodiments, data of these databases 626, 628, and 630 each may include pricing, available services, authentication, and authorization data, and the like.

Server 618 is connected with and may access one or more service/content provider systems 648. Service/content provider systems 648 may be servers or computers hosting a website or online service, such as Netflix, Amazon, iTunes, and the like. Service/content provider systems 648 may also include servers or computers of a LAN. The charging and communication system may further access a vehicle owner's home system 646 such as the home computer network of the user of the electric vehicle 412. In some embodiments, content may be provided by downloading, streaming, or some combination thereof. The server 618 may further be in communication with a distribution system operator 640, energy aggregators 642, billing centers 644, and the like.

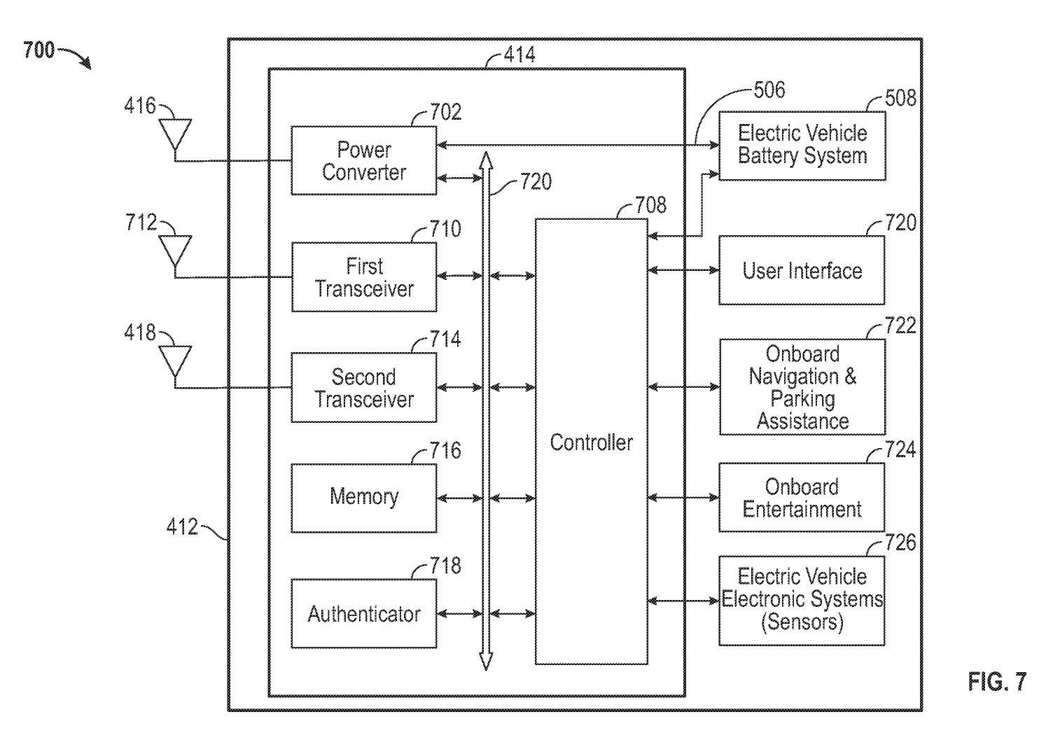

FIG. 7 shows a functional block diagram of an exemplary electric vehicle system 700 in an electric vehicle 412. As shown, vehicle charging and communication system 414 is connected with the electric vehicle battery system 508. The vehicle charging and communication system 414 is further connected to a user interface system 720, an onboard navigation & parking assistance system 722, an onboard entertainment system 724, and electric vehicle electronic systems 726 of the electric vehicle 412. As described above, the vehicle charging and communication system 414 performs activities associated with wirelessly transferring energy (e.g., wireless battery charging) and with transferring content.

The vehicle charging and communication system 414 comprises a controller 708 for coordinating the activities of the vehicle charging and communication system 414. Controller 708 is connected with power converter 702, a first transceiver 710, a second transceiver 714, memory 916, and authenticator 718 by a bus 720. However, in some embodiments, these connections may include dedicated links.

Power converter 702 is further connected with energy storage interface 508 and power antenna 416. Power converter 720 may include an oscillator (not shown), a power amplifier (not shown), a filter (not shown), and a matching circuit (not shown) for efficient coupling with power antenna 416. The oscillator may generate a signal at a frequency. The oscillator signal may be amplified by the power. The filter and matching circuit may be included to filter out harmonics or other unwanted frequencies and to match the impedance of power converter 702 to power antenna 416. The power converter 702 may also include a rectifier (not shown) and switching circuitry (not shown) to generate a suitable power output to charge the battery (not shown) of the electric vehicle battery system 508 or to drive power antenna 416.

A first transceiver 710 is connected with first antenna 712. In some embodiments the first transceiver 710 is used for communicating control messages with a remote device (e.g., an electric vehicle 412). As with the first transceiver 606 of the charging and communication system 402a, control messages may, e.g., relate to initialization, synchronization, power modulation, and the like. In some embodiments, the power antenna 416 may be connected with motors or other actuation devices capable of translating and rotating power antenna 416, and with position or orientation sensors. In such embodiments, first transceiver 710 may use first content antenna 712 to receive or transmit control messages concerning the orientation or position of power antenna 416 or of an antenna of a remote device, such as power antenna 404a.

The second transceiver 714 is further connected with a second antenna 418. In some embodiments, the first and second transceivers 712 and 714 comprise modules that implement a communication interface for communicating with a remote device. For example, the first and second transceivers 710 and 714 may include modules (not shown) that facilitate far-field communication that is compliant with, e.g., Bluetooth, zigbee, DSRC, or cellular standards. In some embodiments, the first and second transceivers 710 and 714 may include modules that facilitate near-field communication that is compliant with, e.g., Near Field Communication standards. In some embodiments, the first and second transceivers 710 and 714 may include a transcoder capable of translating between various coding schemes used by charging and communication system 402a and devices of the electric vehicle 412 or connected with the electrical vehicle 412.

Memory 716 provides data storage space for the vehicle charging and communication system 414. In some embodiments, memory 716 provides data storage space for various communication channels (e.g., for power converter 720, power controller 710, and second transceiver 714). In some embodiments, memory 716 provides data storage space for content data, user data, or program data. In some embodiments, memory 716 provides authentication, authorization, or encryption data. Memory 716 may use, e.g., solid state devices (such as static and dynamic random access memory devices), hard disk drives, and the like. The memory 716 may further comprise a database.

Authenticator 718 may create and process authentication data, e.g., between a charging and communication system 402a and electric vehicle 412, between the user (including the user's portable wireless devices) and the electric vehicle 412, between the user or electric vehicle 412 and content providers. In some embodiments, authenticator 718 includes RFID-like circuitry connected with one or more antennas (e.g., the power antenna) to produce authentication signals. For example, the authenticator 718 may include an authentication circuit connected with the power antenna 416. When the power antenna 416 receives power from the near field of a power antenna of a charging and communication system 402a, the authentication circuit then changes its impedance according to a pattern that is unique to the electric vehicle, and the charging and communication system 402a authenticates the electric vehicle based on sensed changes in impedance.

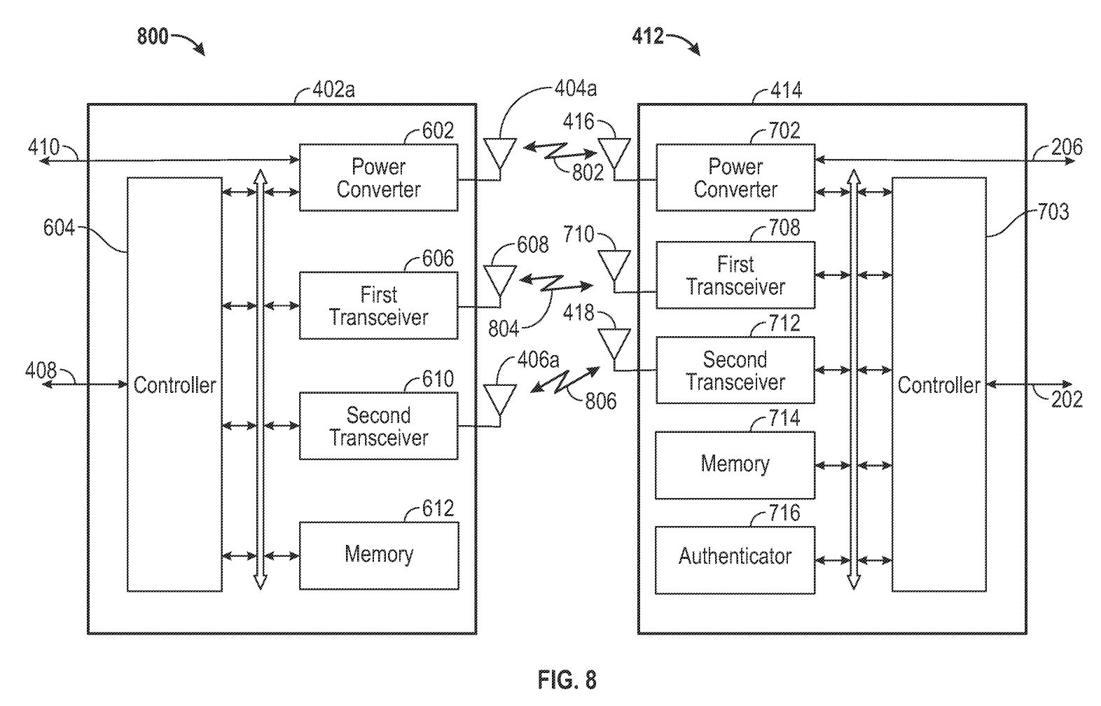

FIG. 8 shows a diagram of an exemplary embodiment of a charging and communication system 402a coupled with vehicle charging and communication system 414. FIG. 8 shows the charging and communication system 402a as described with reference to FIG. 6 and the vehicle charging and communication system 414 as described with reference to FIG. 7. FIG. 8 further shows the coupling and communication links between the charging and communication system 402a and the vehicle charging and communication system 414.

Energy may be transferred between charging and communication system 402a and vehicle charging and communication system 414 by coupling their respective power antennas and thus creating a power link 802. In some embodiments, power link 802 is formed based on far-field radiation. For example, the power antenna 416 of the vehicle 412 may collect and rectify radiated power from power antenna 404a of the charging and communication system 402a for charging a battery (not shown) of the electrical vehicle 412 via the vehicle charging and communication system 414.

In some embodiments, power link 802 is formed based on “magnetic coupled resonance” (or “resonant induction”) when power antennas 404a and 416 (one being a receiving antenna and one being a transmitting antenna) are tuned to substantially common resonance frequencies, and the receiving antenna is brought within the near field of the transmitting antenna. The near-field is an area around the antenna in which electromagnetic fields exist but may not substantially propagate or radiate away from the antenna.

In some exemplary embodiments of the invention, magnetic type antennas such as single and multi-turn loop antennas are used since magnetic near-field amplitudes in some embodiments may be higher for magnetic-type antennas in comparison to the electric near fields of an electric-type antenna (e.g., monopole or dipole). Using a substantially magnetic field may provide low interaction with non-conductive dielectric materials and may provide increased safety relative to a substantially electric field. Notwithstanding, electric-type antennas or a combination of magnetic-type and electric-type antennas are also contemplated.

In some embodiments, loop (e.g., multi-turn loop) antennas may include an air core or a physical core such as a ferrite core. An air core loop antenna may allow the placement of other components within the core area. Physical core antennas including ferromagnetic or ferromagnetic materials may allow development of a stronger electromagnetic field and improved coupling.

To enable wireless high power transfer, some exemplary embodiments may use a frequency in the range from 20-60 kHz. Frequency coupling in this range, or similar ranges, may allow highly efficient power conversion that may be achieved by using state-of-the-art solid state devices. In addition, there may be less coexistence issues with radio systems compared to other bands. However, it is contemplated that some embodiments may use other frequencies.

In order to control energy transfer, charging and communication system 402a and vehicle charging and communication system 414 may communicate messages such as control messages over a first wireless communications link 804 between first antennas 608 and 710. The first wireless communications link 804 may also serve a general communication link. In some embodiments, the first communications link 804 is formed using near-field techniques using in-band frequency signaling. In some embodiments, this link is formed using far-field techniques.

Content may further be communicated over a second wireless communications link 804 between the second antennas 406a and 418 of the charging and communication system 402a and vehicle charging and communication systems 414, respectively. In some embodiments, this the second wireless communications link 806 is formed by using near-field techniques. In some embodiments, this link is formed by using far-field techniques.

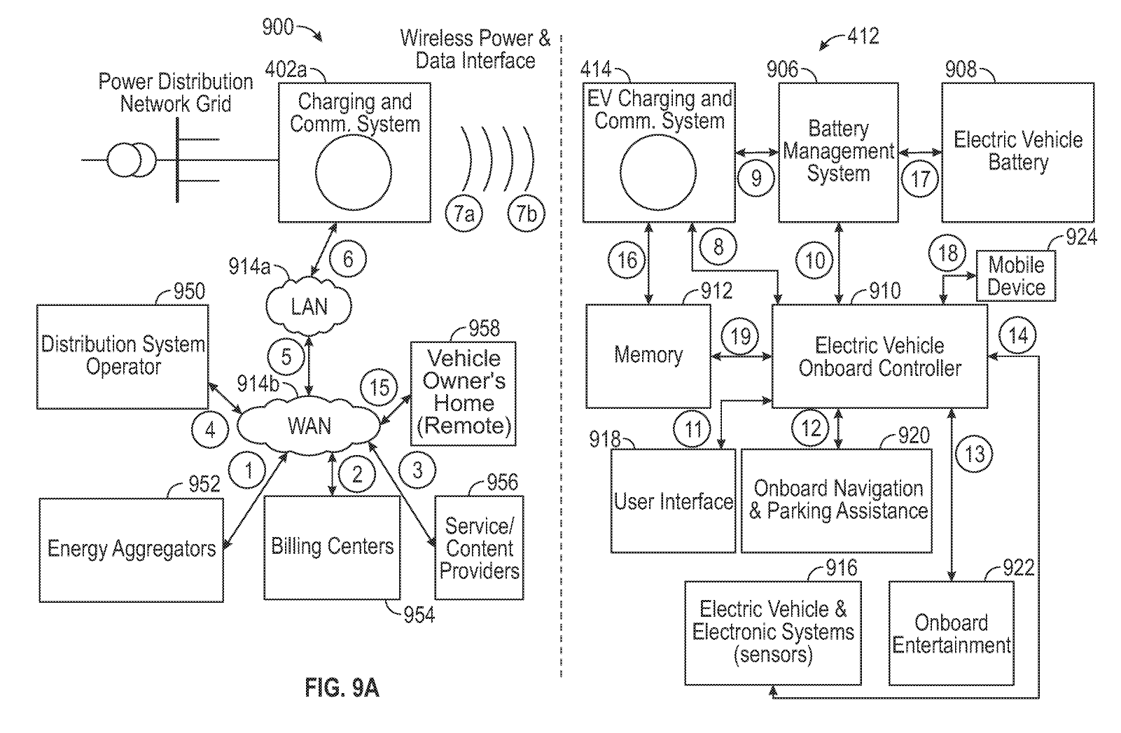

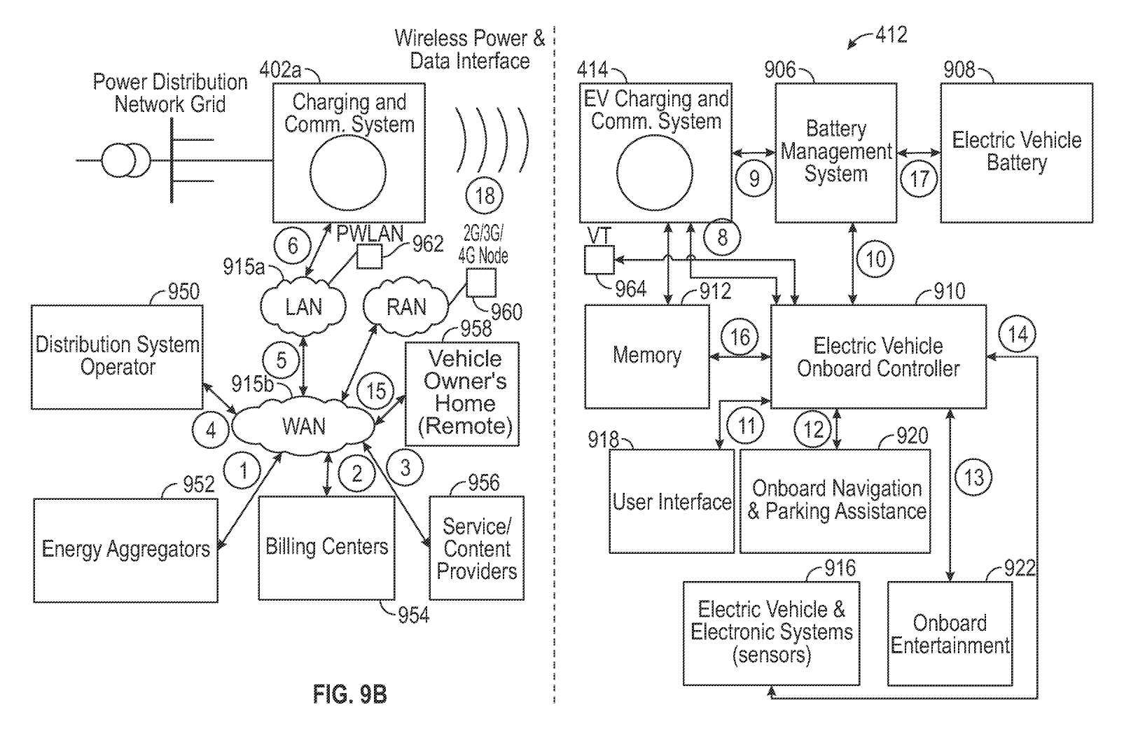

FIG. 9A shows a functional block diagram of an exemplary charging system 900. The charging system 900 includes a charging and communication system 402a as described above. The charging and communication system 402a may connect to and communicate through a local area network (LAN) 915a via the interface 6. The connection to the LAN 915a may be wired or wireless. The LAN 915a may further connect to and communicate through a wide area network (WAN) 915b via interface 5. The connection to the WAN 915b may be wired or wireless. In one embodiment, the WAN 915b may be the Internet. The charging and communication system 402a may communicate through the LAN 915a to various entities of the charging system. The charging and communication system 402a may communicate with a distribution system operator system 950, energy aggregator systems 952, billing centers 954, service/content providers 956, a vehicle owner's home system 958, and the like. Communication interfaces are represented as interfaces 1, 2, 3, 4, 5, and 15.

The charging and communication system 402a may communicate and transfer energy through a wireless power and data interface (7a and 7b) to an electric vehicle charging and communication system 414. The electric vehicle charging and communication system 414 many transfer energy through and communicate with a battery management system 906 to charge an electric vehicle battery 908. Communication interface 9 and 17 may be used. The electric vehicle charging and communication system 414 may further communicate with an electric vehicle controller 910 via a communication interface 8. The electric vehicle charging and communication system 414 may receive and send information from and to any of the charging system systems 950, 952, 954, 956, and 958 through the charging base 902 and the electric vehicle charging and communication system 414. Information received through the charging and communication system 402a and the electric vehicle charging and communication system 414, from the entities 950, 952, 954, 956, and 958, may further be stored in a memory 912. The memory 912 may be a database or any other data storage component. The electric vehicle controller 910 may further communicate with various entities of the electric vehicle including a user interface 918, an onboard navigation & parking assistance system 920, an onboard entertainment system 922, electric vehicle & electronic systems 916, memory, a mobile device 924, and the like via communication interfaces 10, 11, 12, 13, 14, 16, 17, and 18.

The electric vehicle controller 910 (may also correspond to controller 708 of FIG. 7) may communicate with the battery management system 906, the user interface 918, onboard navigation & parking assistance systems 920, onboard entertainment systems 922, and an electronic vehicle & electronic systems 916 (sensors). For example, the electric vehicle charging and communication system 414 may send control signals and/or instructions to any of the electric vehicle systems 906, 908, 912, 904, 916, 918, 920, and 922. Furthermore, the electric vehicle charging and communication system 414 may provide or send data to any of the electric vehicle systems 906, 908, 912, 904, 916, 918, 920, and 922 that may be communicated through the WAN 915b through the charging base 902 and the electric vehicle charging and communication system 414. Furthermore, the electric vehicle controller may further allow communication with a mobile device 924 to send or receive content and information. In one aspect the electric vehicle controller 910 is a port of the vehicle charging and communication system 414.

FIG. 9B shows another functional block diagram of an exemplary charging system similar to the charging system described in FIG. 9A. The system of FIG. 9B further shows additional and/or alternative communication interfaces between a charging system and an electric vehicle 412. In FIG. 9B, a link to a public wireless local area network (PWLAN) 462 may be used in absence of or in conjunction with communication of the wireless power & data interface between the electric vehicle supply equipments 902 and the electric vehicle charging and communication system 414 though a transceiver 964. Moreover, a link to a 2G/3G/4G public cellular network 960 may be used in absence of or in conjunction with communication of the wireless power & data interface between the electric vehicle supply equipments 902 and the electric vehicle charging and communication system 414. Furthermore, if an electric vehicle 412 is using a wired (plug-in) charging connection, then broadband communications between an electric vehicle 412 and a system may be provided using a broadband power line communications technology.

As stated, a variety of different types of information may be exchanged between the charging and communication system 502a and the electric vehicle 412 via the electric vehicle charging and communication system 414 according to embodiments described herein. For example, information may be transferred that is related to wireless power link control data. This data might include data related to power/link management, charge control, antenna alignment, safety systems/sensors, and the like. Antenna alignment might relate to fine alignment with respect to the power antenna 416 and or the electric vehicle 412. In some embodiments, the interface 7a shown in FIG. 4 might be used for wireless power link control related content. In addition, interfaces 8, 9 and 10 may be used for communicating charge control information. In addition, interface 9 may be used to communicate information related to safety systems/sensors.

In addition, information related to foreign object detection may be transferred between the charging and communication system 402a and the electric vehicle 412. For example, the charging and communication system 402a or the electric vehicle 412 may be able to detect a variety of types of foreign objects such as metal objects that may lead to unsafe heating, or other objects such as humans, animals, obstructions, and the like that may impact the safety and use of the system. Information may be transferred related to the type of object detected and the action to perform based on the type of object. For example, information may be sent to alert a user or shut down different components of either the charging and communication system 402a or the electric vehicle 412. Information regarding foreign objects and actions to take may be sent from the charging and communication system 402a to the electric vehicle 412. In addition, in some cases, information relating to foreign object detection may be sent from the electric vehicle 412 to the charging and communication system 402a.

In addition, content may be transferred that is related to the charging infrastructure and electric vehicle system. For example, technology standards information, such as which of the infrastructure standards for energy transfer, communications, and/or vehicle guidance is supported may be transferred. In some embodiments, exemplary communication interfaces involved for communicating technology standards information may include interfaces 7a/7b and 8. In addition, system capability information such as what charge power level is supported or antenna alignment requirements may be transferred. Exemplary communication interfaces involved for communicating system capability information may include interfaces 7a and 7b.

Content may also be transferred that is related to charge service and energy providers. For example, vehicle ID & authentication data may be transferred. In this case, exemplary communication interfaces involved for communicating vehicle ID & authenticating information may include interfaces 3, 5, 6, 7a, 7b, and 8. Charge management data may also be transferred. For example this information might relate to intelligent charging to take into account customer demand and grid capacity (e.g., smart grid, demand side management) and grid management including DSO. Exemplary communication interfaces involved for communicating charge management information may include interfaces 1, 3, 4, 5, 6, and 7b. Information related to energy supplier/aggregators may be transferred. For example this might include the type/mix of energy requested by a user (e.g., CO₂ neutral, zero emission, etc.). Exemplary communication interfaces involved for communicating energy information may include interfaces 1, 3, 5, 6, 7b, 8, and 11. Charge service provider information may also be communicated including information for user pricing, offerings, vehicle to grid incentives, and the like. Exemplary communication interfaces involved for communicating charge service provider information may include interfaces 3, 5, 6, 7b, 8, and 11. Metering and billing information may also be transferred such as metering of the charging based and billing info for the customer. Exemplary communication interfaces involved for communicating metering and billing information may include interfaces 2, 5, 6, 7b, 8, and 11.

Vehicle onboard navigation information may also be transferred. For example, GPS maps or GPS software updates may be provided to the electric vehicle 412. This may allow for downloading updates and obtaining navigation information including information such as locations of electric vehicle charging stations (slow and fast charging), battery swapping stations, park & charge locations (plug-in and wireless), EV maintenance service providers, and the like Exemplary communication interfaces involved for communicating navigation information may include interfaces 3, 5, 6, 7b, 8, and 12. Electric vehicle maintenance service provider information may also be transferred such as the transfer of electric vehicle diagnostic information, data, alerts, reminders, and the like. Exemplary communication interfaces involved for communicating maintenance service information may include interfaces 3, 5, 6, 7b, 8, 11, and 14. Information on local parking lots may also be communicated that may provide status information on available parking places with wireless charging capabilities. Exemplary communication interfaces involved for communicating local parking lot information may include interfaces 3, 5, 6, 7b, 8, and 12. Vehicle guidance and parking assistance information may also be transferred that may allow for providing systems to assist a driver to position a vehicle with required accuracy on a charging sport. Exemplary communication interfaces involved for communicating vehicle guidance information may include interfaces 7a, 8, and 12.

Vehicle management and maintenance may further be provided. For example, information may be transferred relating to electric vehicle components from the manufacturer (of the battery or vehicle). This may allow for transferring of electric vehicle diagnostics/statistics. Exemplary communication interfaces involved for communicating such electric vehicle information may include interfaces 3, 5, 6, 7b, 8, 11, and 14. Electric vehicle software or firmware updates may be provided. For example, software or firmware updates may be downloaded in a garage when the electric vehicle is docked on a charging base. Exemplary communication interfaces involved for communicating electric vehicle update information may include interfaces 6, 7b, and 8. Remote control and information relating to monitoring of electric vehicle onboard systems may further be communicated such as information relating to remote control and monitoring of heating/cooling systems, battery status, and the like. Exemplary communication interfaces involved for communicating monitoring information may include interfaces 15, 5, 6, 7b, 8, and 11. Vehicle localization information such as locating a parked electric vehicle 412 may also be transferred. Exemplary communication interfaces involved for communicating vehicle localization information may include interfaces 3/15, 5, 6, 7b, and 8. Further, data synchronization that may allow for automatic synchronization of user data stored on a vehicle with user data stored on a home drive may be provided. Exemplary communication interfaces involved for communicating data synchronization may include interfaces 15, 5, 6, 7b, 8, and 11/13.

Vehicle onboard infotainment information may further be transferred. For example, updated audio content such as news, sports, radio broadcast content, different language programs, podcasts, and the like may be transferred. In addition, updated video content may be transferred, such as mobile TV content and the like. In addition other video and music may be transferred that may provide for downloading video and music content, synchronization of video and music data stored in the vehicle with a personal electronic device or with a personal computer. Exemplary communication interfaces involved for communicating multimedia information may include interfaces 3, 5, 6, 7b, 8, 11, and 13. In addition broadband internet access may be provided to the electric vehicle 412, for example while parking and charging. Exemplary communication interfaces involved for communicating broadband Internet may include interfaces 3, 5, 6, 7b, 8, and 11.

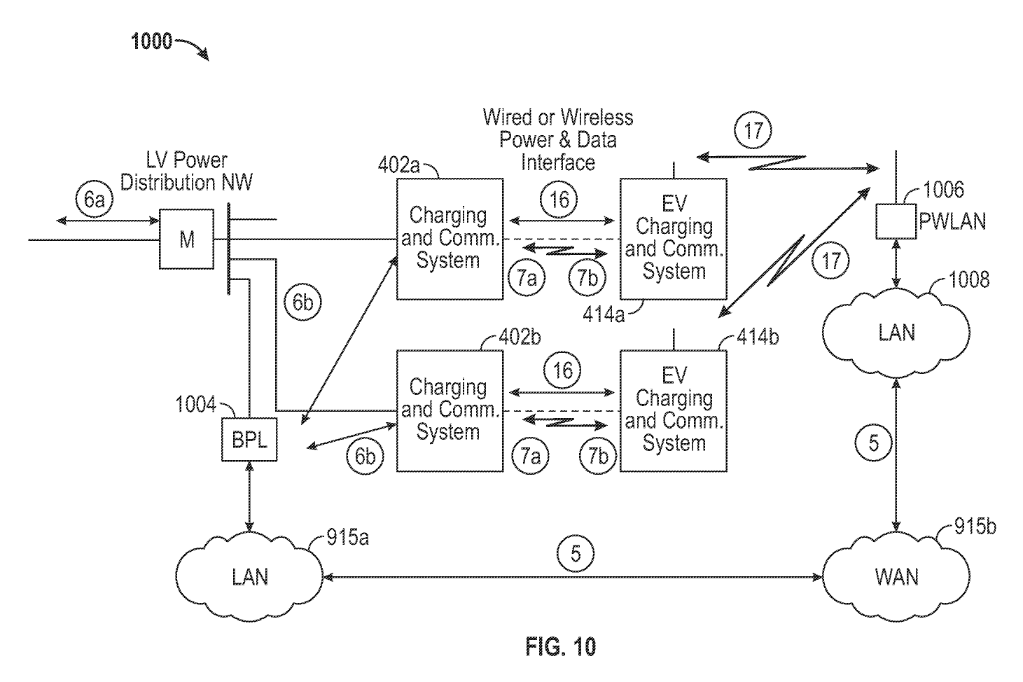

FIG. 10 shows another functional block diagram of an exemplary charging system in a parking lot. For example, the system 1000 may include multiple charging and communication systems 402a and 402b that each allow for charging a corresponding electric vehicle (EV) charging and communication system 414a and 414b in respective electric vehicles (not shown) via communication and power interfaces 16 and 7a and 7b. Other functional blocks shown in FIG. 10 may correspond to the blocks described above in connection with FIGS. 4-9. The charging and communication systems 402a and 402b may receive power from a power grid within some area connected to a wider power grid shown by the interface 6a. Furthermore, the charging and communication systems 402a and 402b may be able to use a communication interface 6b which may include a broadband power line communication (BPL) interface using a broadband power line communication system. The broadband power line communication system may communicate through a LAN 915a and a WAN 915b to provide data and content communication between the charging and communication systems 402a and 402b and a wider network. Furthermore, in some embodiments, the vehicle charging and communication systems 414a and 414b may communicate through a PWLAN 1006 which may further connect to the WAN 915b (e.g., the Internet) through another LAN 1008.

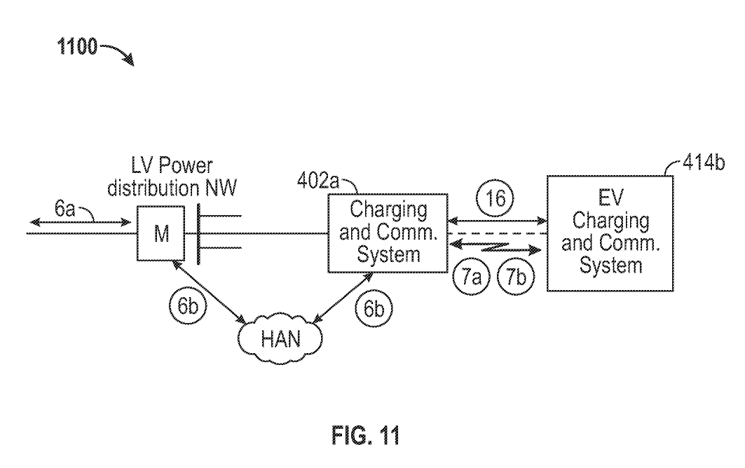

FIG. 11 shows another functional block diagram of an exemplary charging system 1100 that may be installed in a residence. In FIG. 11, the charging and communication system 402a may receive power from a power distribution system connected to a power grid through a power transmission interface 6a. The charging and communication systems 402a may further communicate through an interface 6b to a home area network which may provide further connection to a WAN (not shown). The charging and communication systems 402a may further use communication/power transmission interfaces 16 and 7a and 7b to a Vehicle charging and communication system 414b. As described above, the interfaces me be wired or wireless.

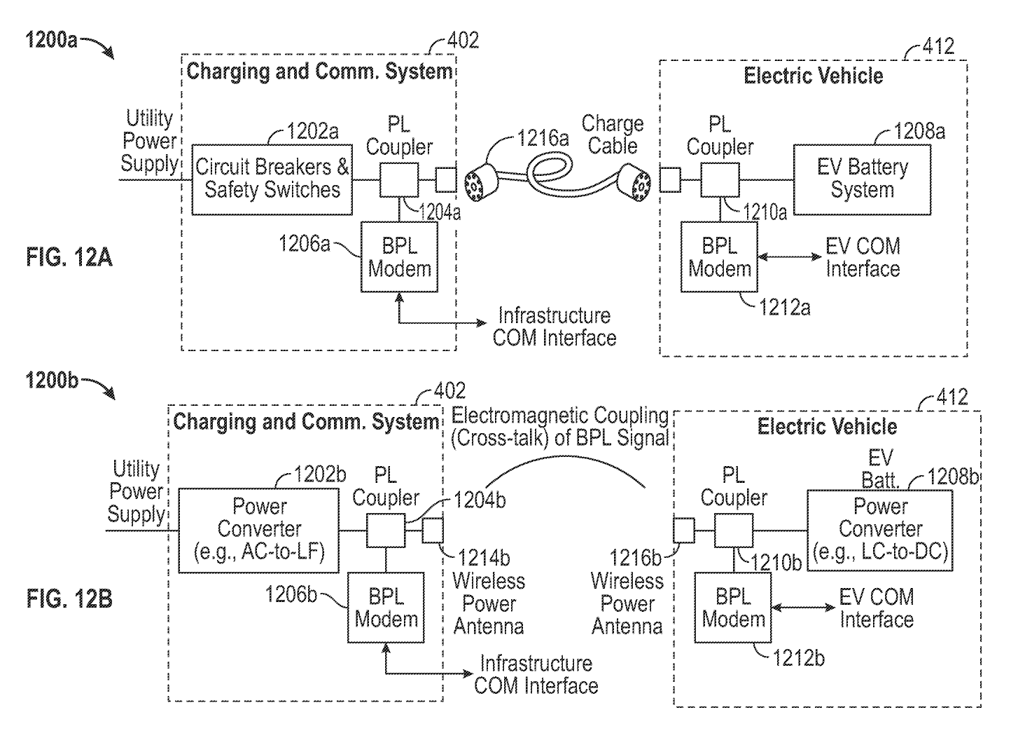

FIG. 12A shows a functional block diagram of an exemplary charging system 1200a using a wired connection. The system 1200a includes a charging and communication system 402a and an electric vehicle 412 system. In FIG. 12A, the charging and communication system 402a is connected to provide power to the EV through a charging cable 1216a. The charging and communication system 402a receives power from a utility power supply. The power from the utility power supply is provided to circuitry 1202a including circuit breaker and safety switches. The power is then provided through a power line coupler 1204a to be provided to the electric vehicle 412 through the charging cable 412. The power from the power line coupler 1204a is provided to a broadband power line modem 1206a which is connected to a system communications (COM) interface for connecting to, for example, a network.

In FIG. 12A, the electric vehicle 412 receives the power from the charging and communication system 402a through the charging cable 1216a and provides the power to a power line coupler 1210a. The power line coupler 1210a provides power to an EV Battery system 1208a. The power line (PL) coupler 1208a additionally provides power to a broadband power line modem 1212a which may interface with an electric vehicle communications (COM) interface.

As such, communications between the charging and communication system 402a and an electric vehicle 412 may happen via wire lines primarily intended for power transmission. In one embodiment, communications signals are superimposed onto the line voltage using a power line signal coupler 1204a that acts in portion as a high pass filter. This high pass filter may separate/decouple the high line voltage (e.g., 115 VAC/60 Hz) from the low level communications signals at high frequency. Power line communications may not need extra wiring for communications but can use existing wiring of power distribution networks or any other lines originally not intended for communications purposes. As the power line data transmission channel is typically a lossy medium, data transmission may be impaired by frequency selective attenuation, frequency selective noise, impulse noise, and multi-path delay spread. As such, power line communication may include powerful error correction and robust modulation schemes to cope with adverse channel conditions. This may be particularly true for high speed (broadband) power line communication. In some areas, power line communication is also known under the term Carrier Current Systems.

Various applications may use narrowband power line communications or broadband power line communications. Applications using narrowband power line communication may include utility applications like automated remote metering and demand side management, remote control over high voltage lines, home automation, professional applications in industry and transport (e.g., automotive), and the like. Application using broadband power line communication (BPL) may typically use a frequency range from 2-30 MHz, and sometimes above 30 MHz. Applications using broadband communications may include local access (“last mile”) solutions, in-home networking (LANs), IT networks, audio & video distribution, and other professional applications in industry and transport (e.g., automotive).

Broadband power line communications may use at least one of the following standards described below: Home Plug (based on OFDM PHY.CSMA-based medium access similar to 802.11 WLAN/WiFi) including HomePlug 1.0 for inhome IT networking (14 Mbps throughput), HomePlug AV for audio & video distribution. (100 Mbps throughput), HomePlug CC (Command & Control) for automation (up to 5 Kbps throughput), HomePlug GP (Green PHY) (3.8 Mbps throughput); HD-PLC (based on wavelet-OFDM PHY—used for audio video distribution); and UPA/OPERA (based on OFDM. Centrally managed, using token-pass medium access) for local access and in-building solutions. Narrowband power line communications may use at least one of the following standards: Echelon, S-FSK, KNX, PRIME, G3, HomePlug CC, and HomePlug Green) which may be used for automated metering, energy management, home automation, and the like.

FIG. 12B shows a functional block diagram of an exemplary charging system 1200b using broadband power line communication via a wireless power transfer field, in accordance with an exemplary embodiments of the inventions. A power converter 1202b, similar to those described above with references to FIGS. 6-8 to convert current from a utility power supply to current that may drive the wireless power antenna 1214b for wireless power transfer (e.g., low frequency AC). A data modulated BPL signal is coupled to a feeder line of the wireless power transfer antenna 1214b via a high-pass filter coupler 1204b. As a result, the weak current of the BPL signal in the MHz range is superimposed on the strong “power” current in the low frequency (LF) range. A BPL modem 1206a at the charging and communication system 402a provides the data modulated BPL signal to the coupler 1204b for superimposing on the strong “power” current. A BPL modem 1212b at the electric vehicle 412 is connected to a power line coupler 1210b that can demodulate the BPL signal superimposed in the current induced in the wireless power antenna 1216b and the electric vehicle 412. The LF current induced in the wireless power antenna 1216b is further converted by the power converter 1208b, similar to the converters described above with reference to FIGS. 7-8, to provide power to the EV battery. Electromagnetic (e.g., near-field) coupling effects (sometimes referred to as cross-talk) between the two power transfer antennas may be sufficient to establish a reliable BPL link between the charging and communication system 402a and the electric vehicle 412 in both directions (forward link and reverse link). As such, the BPL modem 1212b in the electric vehicle 412 can further provide a modulated data signal to the PL coupler 1210b to transfer data to the charging and communication system 402a that may be demodulated by the BPL modem 1206b.

Communication may be provided via BPL even when the wireless power antennas 1214b and 1216b are narrow-band resonant at a low frequency. Depending on the wireless power tuning and matching topology, some additional passive elements (not shown) may be added. As such, the same technology/standard for BPL communications may be used for both wired and wireless charging. Furthermore, in contrast to use of a far-field WLAN technology, broadband communications may be provided via near-field coupling that may allow for more efficient spectrum re-use. In addition, electromagnetic compatibility issues may be similar to use of BPL via a low voltage electricity distribution network using non-shielded and non-twisted wire structures.

Various embodiments are directed to the use of power line communication in a vehicle, such as an automobile. For example, power line communications may be used in a controller area network (CAN), such as a CAN-bus-like solutions onboard a vehicle. This may reduce a vehicle's wiring harness weight/complexity. Furthermore, power line communications may be used for communicating between a charging and communication system 402a and an electric vehicle 412 with wired charging solutions (e.g., “last meter”). In this case, communication can be performed over power wires of rugged charge cable/connectors without need for integrating dedicated filligree communications wires and connector pins (e.g., as required for Ethernet). This may apply only to wired charging solutions. Furthermore, power line communication may be used for backhaul communications with a charging system (e.g., between central power management entity and charging equipment (e.g., in a large multi-story car park) as shown in FIG. 10. This may apply to both wired and wireless charging solutions.

The systems described above may allow for wired or wireless communication for power demand management and many other charging related functions and value-add services could serve as a vital conduit.

Communication between the charging system and the electric vehicle 412 may include a variety of different communications interfaces includes wired (e.g., Ethernet, broadband communication, telecommunication networks, public or provide networks, wireless, in-band signaling on wireless power carrier, out of band communications (RF modem), electric vehicle (EV) LAN, EV controller area network bus, local access network (e.g., DSL), PWLAN (e.g., IEEE 802.11x), 2G/3G/4G mobile network (e.g., GSM, GPRS, EDGE, UMTS, LTE) and the like.

Information relating to discovery of a charging and communication system 402a by an electric vehicle 412 may further be transferred. For example, as there is no physical connection, the electric vehicle 412 and charging and communication system 402a may need to be able to exchange information to be able to setup initial communications etc. In addition, as shown in FIG. 10, there may be multiple charging and communication systems 402a and 402b. When an electric vehicle 412 desires to receive power, information may be exchanged between the systems and the electric vehicle 412 to allow the electric vehicle 412 to establish communications with the desired charging and communication system 402a. As such, certain identification information and location information may be exchanged between the electric vehicle 412 and the charging and communication systems 402a 402b to determine a target charging and communication system 402a and to establish further communications for initiating charging. In addition, measurements of signal strengths or a certain electronic signature may be used to determine which charging and communication system 402a to establish communications with the electric vehicle 412. In addition, physical distance calculation from a charging and communication system 402a may be calculated to determine the correct charging and communication system 402a for charging.

In addition, there may be situations where a charging and communication system 402a is shared between multiple users. As such, where a fully charged electric vehicle 412 is parked over a charging and communication system 402a, the charging and communication system 402a may be unavailable for other electric vehicles that are in need of a charge. In this case, the infrastructure and systems described above may be used for detecting the charge condition of the electric vehicle 412 and notifying the operator of the electric vehicle 412 that there is a need to move the electric vehicle 412 if another user is requesting a charge. For example, a distribution system operator 950 may receive a notification that a vehicle operator is need of a charging and communication system 402a for charging. The distribution system operator system 950 may communicate with various charging and communication systems to determine the availability of a charging and communication system 402a and to determine the charge level of any electric vehicle 412 that is occupying a charging and communication system 402a. If a fully charged electric vehicle 412 is occupying a charging and communication system 402a, the distribution system operator 950 may send a notification, for example via the WAN 914b to the operator of the occupying electric vehicle 412 to move the electric vehicle 412.

In another embodiment, if an electric vehicle 412 occupies a space for longer than necessary, communication may be provided between the electric vehicle 412, the charging and communication system 402a, and the distribution system operator 950 to detect this condition and change the rate being charged for occupying the charging and communication system 402a. For example money could be charged for the duration of occupying the charging and communication system 402a or penalties may be applied.

When an electric vehicle 412 is being positioned to establish charging with a charging and communication system 402a, the battery level of the electric vehicle 412 may be low and there may be insufficient power to transfer high bandwidth data from the electric vehicle 412. However, a certain amount of information may need to be transferred between the electric vehicle 412 and the charging and communication system 402a before charging may take place. From this example, it may be desirable to use different types of communication links at different times based on the charging process. For example, both a low power communication link (that may be low bandwidth for example) and a higher power communication link (that may provide higher bandwidths) may both be used. In one embodiment, the low power/lower bandwidth communication link may first be used to establish charging of the electric vehicle 412. Once the battery is being charged and power consumption of the battery is less of a concern, a higher power/bandwidth communication link may be established for communicating larger amounts of content based on the type and need.

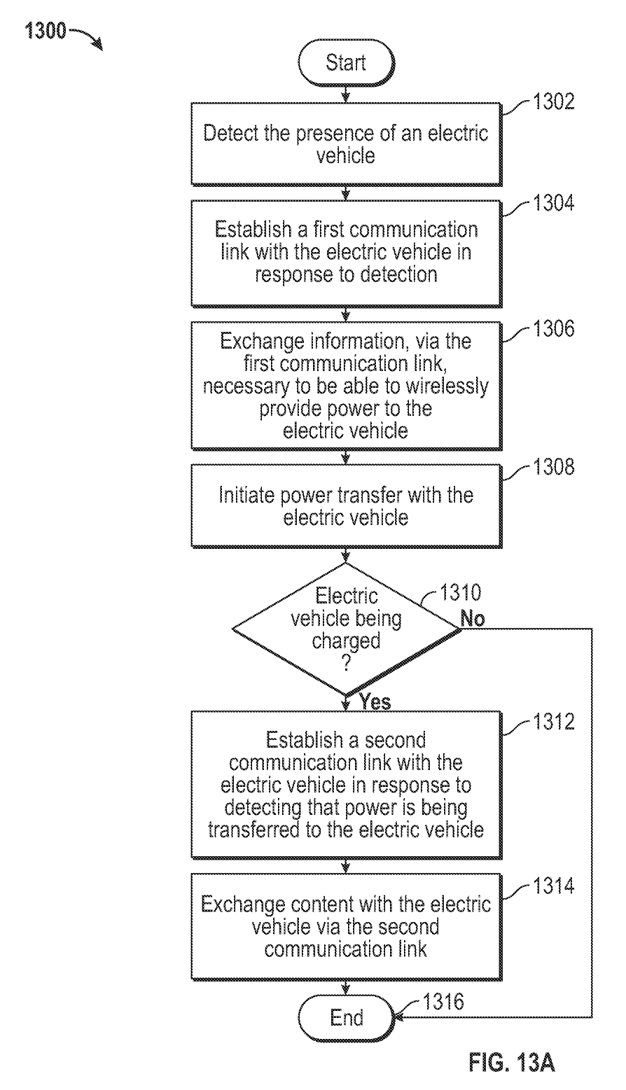

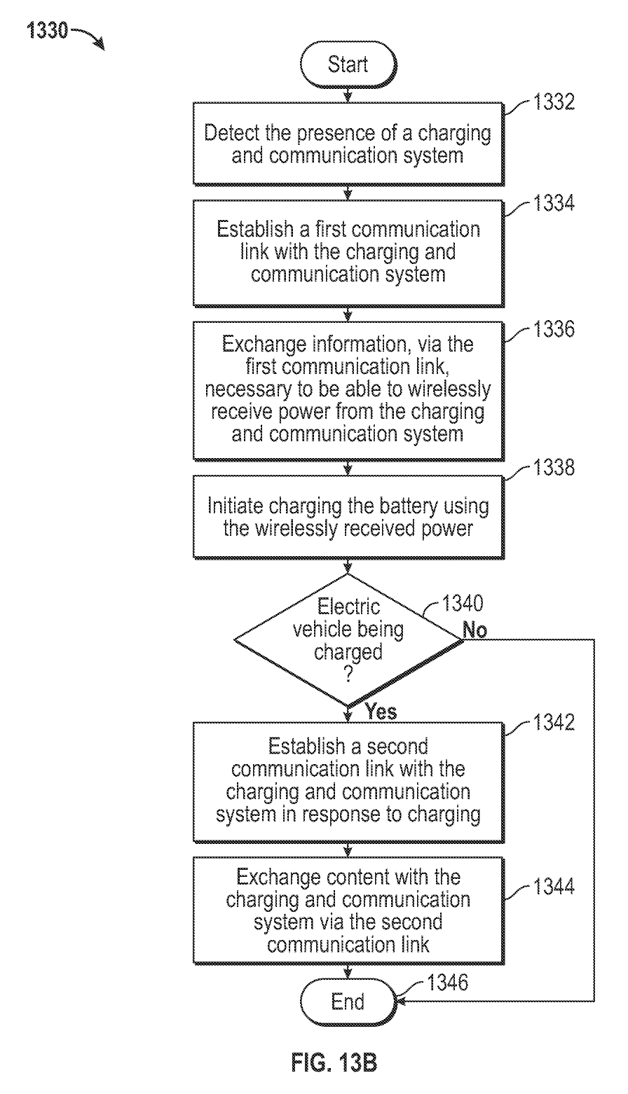

FIG. 13A is a flowchart of an exemplary method 1300 for wireless charging an electric vehicle and exchanging content with the electric vehicle 412. The method 1300 may be performed, for example, at the charging and communication system 402a with reference to FIG. 8. At block 1302, the presence of an electric vehicle 412 is detected. For example, the charging and communication system 402a may detect a change in a wireless field used for power transfer when the electric vehicle power antenna 416 comes within some distance of the charging and communication system 402a. In other embodiments, a user of the electric vehicle 412 may provide manual or electrical user input to alert the charging and communication system 402a that an electric vehicle 412 is approaching. In other embodiments another communication mechanism may be used between the electric vehicle 412 and the charging and communication system 402a to signal that the electric vehicle 412 is approaching or is positioned to receive power from the charging and communication system 402a.

In response to the detection of block 1302, at block 1304, a first communication link 804 is established with the electric vehicle 412. For example, the controller 604 of the charging and communication system 402a may establish a first communication link 804 using the first transceiver 606 of the charging and communication system 402a. In another embodiment, the charging and communication system 402a may use in-band signaling by establishing a communication link via the wireless power transfer field 802. In-band signaling may be accomplished, in one aspect, by impedance or load modulation of the wireless power transfer field between the charging and communication system 402a and the vehicle charging and communication system 414. The first communication link 804 may be a low power communication link as compared to a communication link that may be used for subsequent content transfer between the charging and communication system 402a and the electric vehicle 412. Stated another way, the controller 604 of the charging and communication system 402a may communicate via a first communications link at a power level that is lower than a power level of a communication link for subsequent content transmissions. In one embodiment, the first transceiver 606 of the charging and communication system 402a may be configured to communicate via Bluetooth, Zigbee, IEEE 802.15, UWB, dedicated short range communication (DSRC) (or communications based on 802.11p), wireless USB communications protocols, or the like. These protocols and hardware configuration may provide lower bandwidth as compared to other communication protocols, but may consume significantly less power. In this case, little power may be needed in the electric vehicle 412 to establish the first communications link 804.

After establishing the first communication link 804, at block 1306, information may be exchanged via the first communication link 804 that is necessary or useful to be able to wirelessly provide power with the electric vehicle 412. For example, the information transferred might relate to charging information. In another aspect, information may be transferred relating to detection of the electric vehicle 412, primary authentication of the electric vehicle 412, alignment of the electric vehicle 412 over the power antenna 404a of the electric vehicle 412, battery level information of the electric vehicle 412, and the like. In one aspect, information relating to alignment may be transferred that provides information for an automatic park assist. In another aspect, system capability information may be transferred to allow for determining capability of the charging and communication system 402a and the electric vehicle 412. In another aspect, charging parameters such as maximum or minimum power levels, charge rate, safety information, tuning of the power antennas 404a and 416, and the like may further be transferred. In some cases, this information may be needed before the charging and communication system 402a is able to begin wirelessly providing higher levels of power for charging. This information may be information that is transmitted before wireless power transfer for charging the electric vehicle 412 begins. In this case, the battery of the electric vehicle 412 may continue to be used to power the first communication link 804 thus putting a strain on the battery.

At block 1308, based on the information exchanged in block 1306, power transfer with the electric vehicle 412 is initiated. In this case, the charging and communication system 402a may begin to wirelessly output power at sufficiently high levels to allow for effectively charging the electric vehicle 412 and/or powering other systems of the electric vehicle 412. At block 1310, it is detected whether the electric vehicle 412 is being charged. For example, the charging and communication system 402a may receive feedback from the electric vehicle 412 via the first communications link that the battery of the electric vehicle 412 is being charged. If the electric vehicle 412 is being charged, then at block 1312, a second communication link 806 is established with the electric vehicle 412 in response to detecting that power is being transferred. For example the controller 604 of the charging and communication system 402a may establish a second communication link 806 via the second transceiver 610. The second communication link 806 may use higher power levels than the first communication link 804. The second communication link 806 may transfer data at greater bandwidths than the first communication link 804. In some embodiments, the second transceiver 610 may be configured to transfer data via the second communication link 806 using a communication protocol such as Wi-Fi, WiMax, UMTS, LTE, HSPA, GPRS, Flash-OFDM, EV-DO, EDGE, RTT, and the like.

At block 1314, content is exchanged with the electric vehicle 412 via the second communication link 806. For example, information relating to further charging control parameters (e.g., for tuning power transfer), further system capabilities, billing, metering, data for an onboard navigation system, electric vehicle maintenance, electric vehicle system updates, electric vehicle system monitoring, multimedia content, and the like may be transferred. Any of the content described herein is further contemplated. In one aspect, the controller 604 of the charging and communication system 402a may be configured to synchronize content stored in the electric vehicle 412 with content stored on a network via the second communication link 806. As described above with reference to FIGS. 9A and 9B, it should be appreciated that the charging and communication system 402a may act as an intermediary communication link between external systems and the electric vehicle 412 for communicating information.

If at block 1310, it is detected that the electric vehicle 412 is not being charged, the second communication link 806 may not be established and the method may end at block 1316. In this case, there may not be sufficient power in the electric vehicle 412 to communicate at higher power levels. Furthermore, in an embodiment, once the second communication link 806 is established, the first communication link 804 may be terminated. In this case, charging information that is transferred after first establishing the wireless power link may be done via the second communication link 806. However, in some embodiments the first communication link 804 may be continuously used during charging for communicating charging information.

FIG. 13B is a flowchart of an exemplary method 1330 for wireless receiving power and exchanging content with a charging and communication system 402a. In some embodiments, the method 1330 may be performed by the electric vehicle 412 with reference to FIG. 8. At block 1332, the presence of a charging and communication system 402a may be detected. For example, the electric vehicle 412 may detect a low power beacon signal from the charging and communication system 402a based on the wireless field used for power transfer when the electric vehicle power antenna 416 comes within some distance of the charging and communication system 402a. In other embodiments, a user of the electric vehicle 412 may provide manual or electrical user input to indicate the user is pulling up to a charging and communication system 402a. In other embodiments, another communication mechanism may be used between the electric vehicle 412 and the charging and communication system 402a to signal that the electric vehicle 412 is approaching or is positioned to receive power from the charging and communication system 402a.

In response to the detection of block 1332, at block 1334 a first communication link 804 is established with the charging and communication system 402a. For example, the controller 706 of the electric vehicle 412 may establish a first communication link 804 using the first transceiver 708 of the electric vehicle 412. In another embodiment, the electric vehicle 412 may use in-band signaling by establishing a communication link via the wireless power transfer field 802. In-band signaling may be accomplished, in one aspect, by impedance or load modulation of the wireless power transfer field between the charging and communication system 402a and the vehicle charging and communication system 414. The first communication link 804 may be a low power communication link as compared to a communication link that may be used for subsequent content transfer between the electric vehicle 412 and the charging and communication system 402a. Stated another way, the controller 706 of the electric vehicle 412 may communicate via a first communications link at a power level that is lower than a power level of a communication link for subsequent content transmissions. In one embodiment, the first transceiver 708 of the electric vehicle 412 may be configured to communicate via Bluetooth, Zigbee, IEEE 802.15, UWB, dedicated short range communication (DSRC) (or communications based on 802.11p), wireless USB communications protocols, or the like. These protocols and hardware configurations may provide lower bandwidth as compared to other communication protocols, but may consume significantly less power. In this case, little power may be provided by the electric vehicle 412 to establish the first communications link 804.

After establishing the first communication link 804, at block 1336, information may be exchanged, via the first communication link 804, that is needed to be able to wirelessly receive power from the charging and communication system 402a. For example, the information transferred might relate to charging information. In another aspect, information may be transferred relating to detection of the charging and communication system 402a, primary authentication of the electric vehicle 412, alignment of the electric vehicle 412 over the power antenna 404a of the charging and communication system 402a, battery level information of the electric vehicle 412, and the like. In one aspect, information relating to alignment may be transferred that provides information for an automatic park assist. In another aspect, system capability information may be transferred to allow for determining capability of the charging and communication system 402a and the electric vehicle 412. In another aspect, charging parameters such as maximum or minimum power levels, charge rate, safety information, tuning of the power antennas 404a, and 416, and the like may further be transferred. In some cases, this information may be needed before the electric vehicle 412 is able to begin wirelessly receiving higher levels of power for charging. This information may be information that is transmitted before wireless power transfer for charging the electric vehicle 412 begins. In this case, the battery of the electric vehicle 412 may continue to be used to power the first communication link 804 thus putting a strain on the battery.

At block 1338, based on the information exchanged in block 1338, power transfer with the charging and communication system 402a is initiated. In this case, the electric vehicle 412 may begin to wirelessly receive power from the charging and communication system 402a at sufficiently high levels to allow for effectively charging the electric vehicle 412 and/or powering other systems of the electric vehicle 412. At block 1330, it is detected whether the electric vehicle 412 is being charged. For example, the electric vehicle 412 may detect charging and provide feedback to the charging and communication system 402a via the first communications link that the battery of the electric vehicle 412 is being charged. If the electric vehicle 412 is being charged, then at block 1332, a second communication link 806 is established with the charging and communication system 402a in response to detecting that power is being transferred. For example the controller 706-of the electric vehicle 412 may establish a second communication link 806 via the second transceiver 712 of the electric vehicle 412. The second communication link 806 may use higher power levels than the first communication link 804. For example, the second communication link 806 may transfer data at greater bandwidths than the first communication link 804. In some embodiments the second transceiver 712 may be configured to transfer data via the second communication link 806 using a communication protocol such as Wi-Fi, WiMax, UMTS, LTE, HSPA, GPRS, Flash-OFDM, EV-DO, EDGE, RTT and the like. The controller 706 of the electric vehicle 412 may establish the second communication link 806 using power derived from power that was wirelessly transferred from the charging and communication system 402a.

At block 1334, content is exchanged with the charging and communication system 402a via the second communication link 806. For example, information relating to further charging control parameters (e.g., for tuning power transfer), further system capabilities, billing, metering, data for an onboard navigation system, electric vehicle maintenance, electric vehicle system updates, electric vehicle system monitoring, multimedia content, and the like may be transferred. Any of the content described herein is further contemplated. In one aspect, the controller 706 of the electric vehicle 412 may be configured to synchronize content stored in the electric vehicle 412 with content stored on a network connected to the charging and communication system 402a via the second communication link 806. As described above with reference to FIGS. 9A and 9B, it should be appreciated that the charging and communication system 402a may act as an intermediary communication link between external systems and the electric vehicle 412 for communicating information to the electric vehicle 412.

If at block 1330, it is detected that the electric vehicle 412 is not being charged, the second communication link 806 may not be established and the method may end at block 1336. In this case, there may not be sufficient power in the electric vehicle 412 to communicate at higher power levels. Furthermore, in one embodiment, once the second communication link 806 is established, the first communication link 804 may be terminated. In this case, subsequent charging information may be communicated via the second communication link 806. However, in some embodiments the first communication link 804 may be continuously used during charging for communicating charging information.

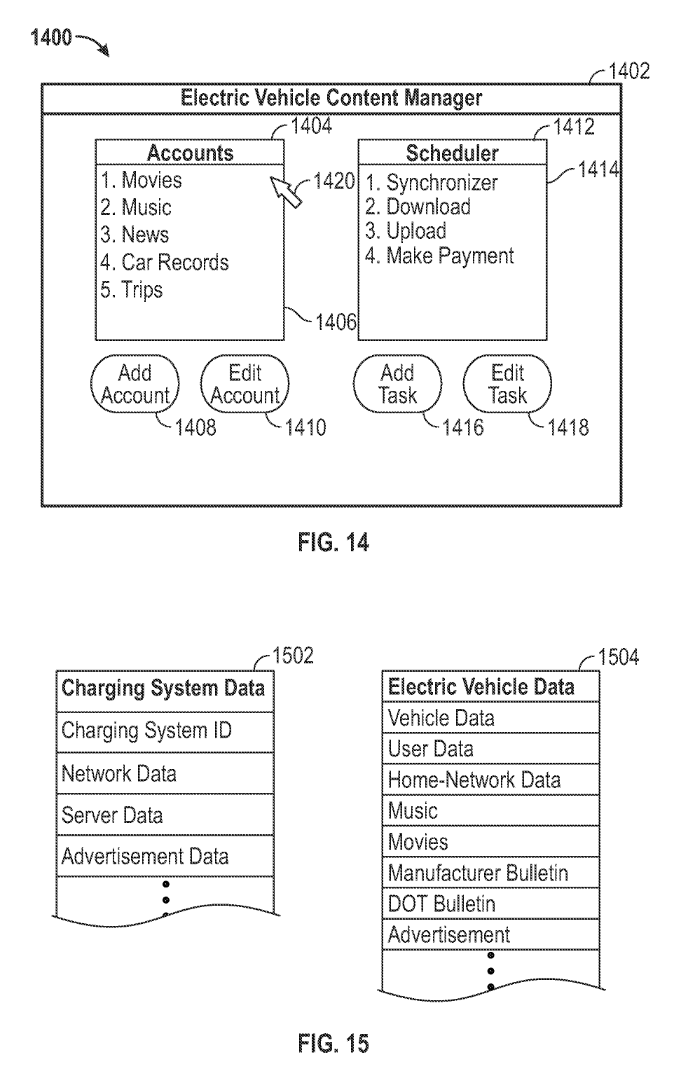

With reference to FIG. 8, in order to coordinate content that will be transferred between the charging and communication system 402a and the vehicle charging and communication system 414, systems may be provided that allow a user to manage content transfers. For example, FIG. 14 shows an exemplary graphical user interface 1400 for configuring user accounts. User interface 1400 includes a content manager window 1402 comprising an account frame 1404 with associated add account 1408 and edit account 1410 buttons and a scheduler frame 1412 with associated add task 1416 and edit task 1418 buttons. In some embodiments the user may interact with the user interface 1400 with a cursor 1420 controlled by a keyboard, mouse, voice-recognition software, gesture-capture software, or touch screen.

Accounts frame 1404 lists various accounts 1406 corresponding to a user of the electrical vehicle 412. Each account may specify data related to the user's selected services and preferences associated with a content provider (e.g., content provider 732). For example, an account may specify a URL of a content provider, a user's financial data (e.g., credit card information), parental controls, and authorization data (e.g., user names and passwords). In some embodiments, accounts may govern a number of types of content, including movies, music, news, car records, trip information, and the like.

Scheduler frame 1412 lists various tasks 1412 scheduled for an electrical vehicle 412. Each task specifies one or more acts to be performed at certain times or triggered by certain events. For example, a task may specify that the vehicle charging and communication system 414 synchronize content with a computer connected with a home LAN, when the electrical car 412 initiates a wireless charge with a charging and communication system 402a connected with the home LAN. For further example, the vehicle charging and communication system 414 may be directed to periodically check for available downloads from a certain content provider, make payments to one or more content providers, refresh its content, or upload data to a specified website. For yet further example, the vehicle charging and communication system 414 may be directed to automatically set the state of a smart home (e.g., turn lights on, unlock doors, set thermostat), triggered when the vehicle charging and communication system 414 couples or uncouples with a charging and communication system 402a that is located at the user' home.

As illustrated in the example embodiment depicted in FIG. 14, a user may add an account by clicking on the add account button 1408 and edit a selected account by clicking the edit account button 1410 Likewise, a user may add a task by clicking on the add task button 1416 and edit a selected task by clicking the edit task button 1418. In some embodiments, clicking on one of these buttons may instantiate a new window for specifying or modifying details of a selected account or task.

User interface 1400 may be implemented on a variety of platforms. In some embodiments, the user interface 1400 is a webpage accessed by a desktop computer or mobile device. For example, a website that provides user interface 1400 may access and edit data stored in the accounts database 724, including the electric vehicle database 728. In some embodiments, the user interface 1400 is provided as part of an on-board user interface of the electric vehicle 412. For example, the user may modify his accounts and tasks by using an in-dash video display, and the modifications may be saved to memory 816 of the vehicle charging and communication system 414. In such a situation, the next time the vehicle charging and communication system 414 couples to the charging and communication system 402a, charging and communication system 402a may synchronize the data stored in the electric vehicle database 728 of the accounts database 724 with the data stored in the memory 816 of vehicle charging and communication system 414.

FIG. 15 shows various exemplary content data structures 1500 associated with either charging and communication system 402a or vehicle charging and communication system 414. For example, charging and communication system 402a may maintain a charging system data structure 1502 comprising fields including charging system identification data, network data, server data, advertisement data, and the like. In some embodiments, during wireless transfer the charging and communication system 402a receives data to update charging system data structure 1502. In some embodiments, updates are received by one of the charging and communication system's 402a antennas (404a, 406a, or 412), or via communication line 408. The charging and communication system 402a may store charging system data structure in memory 612 of the charging and communication system 402a. In some embodiments, charging system database 626 of the accounts database 624 (FIG. 6) stores at least a portion of charging system data structure 1502. In such cases, charging and communication system 402a may access the charging system data structure 1502 through server 618.

As stated, electrical vehicle 412 may also receive or store various content. FIG. 15 also shows an exemplary electric vehicle data structure 1504 maintained by a vehicle charging and communication system 414. For example, the vehicle charging and communication system 414 may receive vehicle data (e.g., make, model, year), user data (e.g., user name, accounts, and tasks), home-network data (e.g., automatic log-in data), music, movies, manufacturer bulletin (e.g., product recalls), Department of Transportation (DOT) bulletin (e.g., nearby car accidents, dangerous weather, and road closures), and advertisements (e.g., advertisement content and user profiling data). Such content and data may be maintained in the memory 716 of the vehicle charging and communication system 414, or maintained by an on-board storage device (not shown) of the electrical vehicle 412. In some embodiments, such content is relayed or sent directly to personal devices (e.g., Bluetooth or Wi-Fi enabled devices) linked with the electrical vehicle 412. In some embodiments, electric vehicle database 628 of the accounts database 624 stores at least a portion of electric vehicle data structure 1504. In such cases, charging and communication system 402a may access the electric vehicle data structure 1504 through server 618.

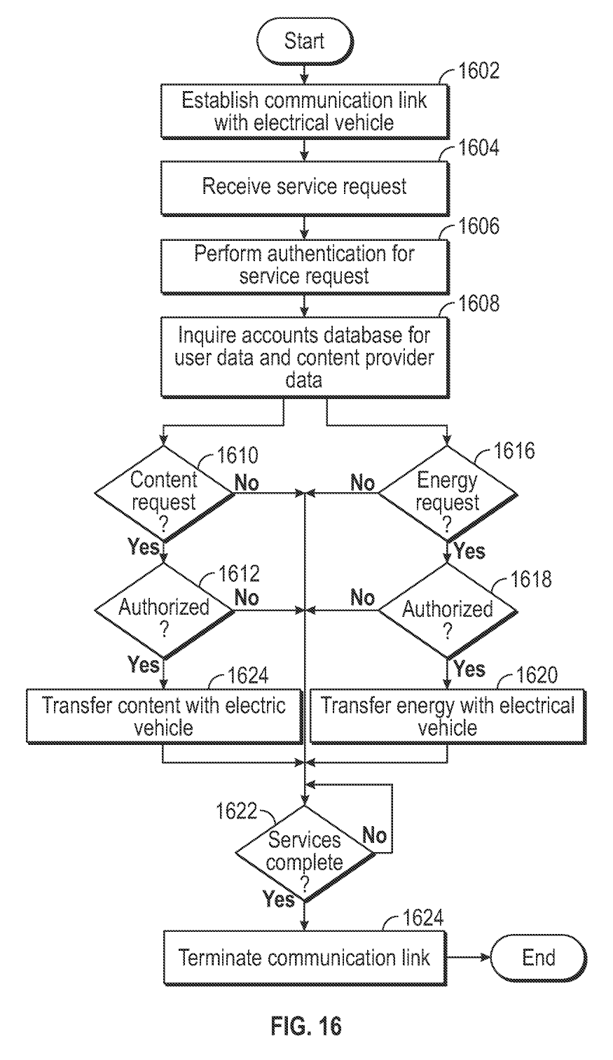

FIG. 16 is a flow chart of an exemplary method 1600 performed by the charging and communication system 402a for transferring energy and content, in accordance with an exemplary embodiment of the present invention. Method 1600 begins with block 1602, in which the charging and communication system 402a establishes a communication link with electrical vehicle 412. The communication link may be established according to any suitable communication protocol.

Charging and communication system 402a may establish a communication link responsive to sensing electrical vehicle 412. For example, charging and communication system 402a may receive a signal at one of its antennas (404a, 608, 406a), the signal being transmitted by electrical vehicle 412 for initiating or requesting communication with charging and communication system 402a. The charging and communication system 402a then responds according to a communication protocol. In some embodiments, the charging and communication system 402a senses the electrical vehicle 412 by using one or more sensors (e.g., pressure or infrared sensors). In such a case, the charging and communication system 402a may attempt to establish communication with the vehicle charging and communication system 414 responsive to the outputs of the one or more sensors. However, it is also contemplated that the charging and communication system 402a may perform block 1602 continuously or periodically attempt to establish communication with an electric vehicle, without being responsive to a signal from electric vehicle 412 or a signal from a sensor—i.e., the charging and communication system 402a may attempt to discover nearby electric vehicles 412.

In some embodiments, the communication link corresponds to control link 404. However, it is also contemplated that the communication link may correspond to power link 402 or content link 406, or some combination of links 402, 404, and 406.

Accordingly, in some embodiments, charging and communication system 402a may establish the communication link with vehicle charging and communication system 414 by using the control antenna 708. However, it is contemplated that the charging and communication system 402a may establish the communication link with any combination of the power antenna 404a, the control antenna 708, and the antenna 406a, or with any other antenna (not shown).

After a communication link has been established, at block 1604 charging and communication system 402a receives a service request from electric vehicle 412. A service request may include a request for the charging and communication system 402a to transmit energy or content to the electrical vehicle 412. In some embodiments, content or energy may also flow from the electrical vehicle 412 to the charging and communication system 402a.

The specificity of the service request may vary. In some embodiments, the service request may be a general request signal without specifying any particular service. In that case, the received service request may be used to initiate authentication and authorization protocols (at blocks 1606 and 1608), and afterwards the vehicle charging and communication system 414 may request more specific services. Further, at block 1608, charging and communication system 402a may determine specific services by querying server 618. In turn, server 618 may determine specific services by accessing, e.g., electric vehicle database 628 of accounts database 624. In some embodiments, the service request may signal certain types of broad services, such as “update accounts” or “synchronize content.” In that case, similar to the previously described case, charging and communication system 402a may query server 718 to determine which specific services correspond to the broad service requests. In some embodiments, the service request may signal certain types of specific services, such as a request to download a specific movie from a specific content provider.

The method 1600 includes block 1606, in which the charging and communication system 402a performs authentication. For example, authentication may include actions for authenticating the electric vehicle 412, for authenticating the charging and communication system 402a, or for authenticating both electric vehicle 412 and charging and communication system 402a (i.e., mutual authentication). In some embodiments authentication may also involve one or more content providers. In some embodiments, authentication may also include authenticating personal devices linked with the electrical vehicle. Authentication may be based on any suitable authentication scheme, e.g., challenge-request schemes.

For example, assuming that authentication is based on a mutual challenge-request scheme, controller 604 may request server 618 for a challenge message to send to the vehicle charging and communication system 414. In response, server 618 creates a challenge message (by using authenticator 620) and sends the challenge message over network 614 to controller 604. In turn, controller 604 transmits the challenge message over controller antenna 608. When charging and communication system 402a receives a response message from the vehicle charging and communication system 414, controller 604 inquires authenticator 620 to determine whether the received response was the expected value. If the received response message matches the expected value, then the electric vehicle is authenticated. Additionally, the charging and communication system 402a receives a second challenge message. In response, controller 604 queries server 618 for a second response message, which the server generates by using authenticator 620 and sends to the charging and communication system 402a. Controller 604 then transmits the second response message to the electric vehicle in order for the electric vehicle 412 to authenticate the charging and communication system 402a.

In some embodiments, mutual authentication may not be needed. For example, an electric vehicle may not require authentication of a charging and communication system 402a that has a known and secure location (e.g., within a personal garage). In some situations, the vehicle charging and communication system 414 may not need to be authenticated. For example, the charging and communication system 402a may allow unrestricted Internet access, in which case the charging and communication system 402a need not authenticate the vehicle charging and communication system 414.

In some embodiments, the charging and communication system 402a performs steps of an authentication process with one or more content providers. For example, in some embodiments the charging and communication system 402a sends authentication messages to content provider 648 so that content provider 648 may authenticate the charging and communication system 402a. In some embodiments, charging and communication system 402a may act as a secure authenticator for an electric vehicle 412. In that case, the content provider 648 may send vehicle charging and communication system 414 an authentication request, and the vehicle charging and communication system 414 may redirect that authentication request to the charging and communication system 402a. In response, the charging and communication system 402a generates an authentication response, on the behalf of vehicle charging and communication system 414. The charging and communication system 402a may send the authentication response to the vehicle charging and communication system 414, which may in turn forward the authentication message to the content provider 648 for authentication.

In some embodiments, authentication data is encrypted. In such a situation, the authenticator 620 of the server 618 may perform the necessary steps of encrypting and decrypting authentication data. Example encryption methods include, e.g., public-key cryptography schemes.

At block 1608 the charging and communication system 402a may query accounts database 624 for user data and content-provider data. For example, controller 604 of the charging and communication system 402a may request that server 618 provide user data corresponding to the authenticated user of the vehicle charging and communication system 414. The user data is located in, e.g., electric vehicle database 628. User data may include data related to accounts and tasks data, and each may define requested services to be performed. The controller 604 also requests the server 618 to send content-provider data. The content-provider data is data that relates to a content provider specified in the service request signal of block 1604, in the user account data provided in this block, or to some combination thereof.

Controller 604 may use the user data and content-provider data to determine whether a user is authorized for the signaled service requests. For example, user data and content-provider data may directly provide the necessary data needed to authorize the user. In some embodiments, content-provider data of database 630 does not include data needed for authorization, but does include data needed to access the content provider 648 over network 614. In such a situation, the controller 604 communicates with the content provider 648 to determine whether the user (corresponding to the user data) is authorized for the services of the request. In some embodiments, based on the user data and the content-provider data, the controller 604 may establish a communication link between the vehicle charging and communication system 414 and the content provider 648, and vehicle charging and communication system 414 and content provider 648 communicate together to determine whether the user of vehicle charging and communication system 414 is authorized.

If content service is requested and if the necessary authorization procedures were successful, then at block 1614 the charging and communication system 402a transfers content with the electric vehicle 412 over antenna 406a. As stated, the specific content that is transferred may be specified in various ways. For example, the content may be specified in the service request message of block 1604. Further, the content may be transferred automatically. For example, the user of electric vehicle 412 may have created a task to check for and download new content of a certain type or offered by a certain content provider. This task information may be specified via user interface 1400 and stored, e.g., in electric vehicle database 628 as part of a charging system data structure 1502 (e.g., user profile) associated with the electric vehicle or the user.

If energy service is requested and if the necessary authorization procedures were successful, then at block 1620 the charging and communication system 402a transfers energy with the electric vehicle 412 over power antenna 404a. The details of the energy service (e.g., amount and rate of energy to be transferred) may be specified in various ways. For example, these details may be specified in the service request message of block 1604. Further, energy may be transferred automatically. For example, the user of electric vehicle 412 may have created a task to fully charge the batteries of the electric vehicle 412 whenever coupled with a charging and communication system 402a of a certain type. This task information may be specified via user interface 600 and stored, e.g., in electric vehicle database 628 as part of a charging system data structure 1502 (e.g., user profile) associated with the electric vehicle or the user.

Once all service requests are complete, the charging and communication system 402a terminates the communication link. In some embodiments this step includes housekeeping steps such as finalizing financial transactions and updating certain records kept in, e.g., charging system database 626, electric vehicle database 628, and content-provider database 630. Other housekeeping steps may include signaling to the electric vehicle that transfers, financial transactions, and other related activities are complete and that the communication link is to be terminated. In some embodiments, charging and communication system 402a signals to the content providers that the communication link is to be terminated.

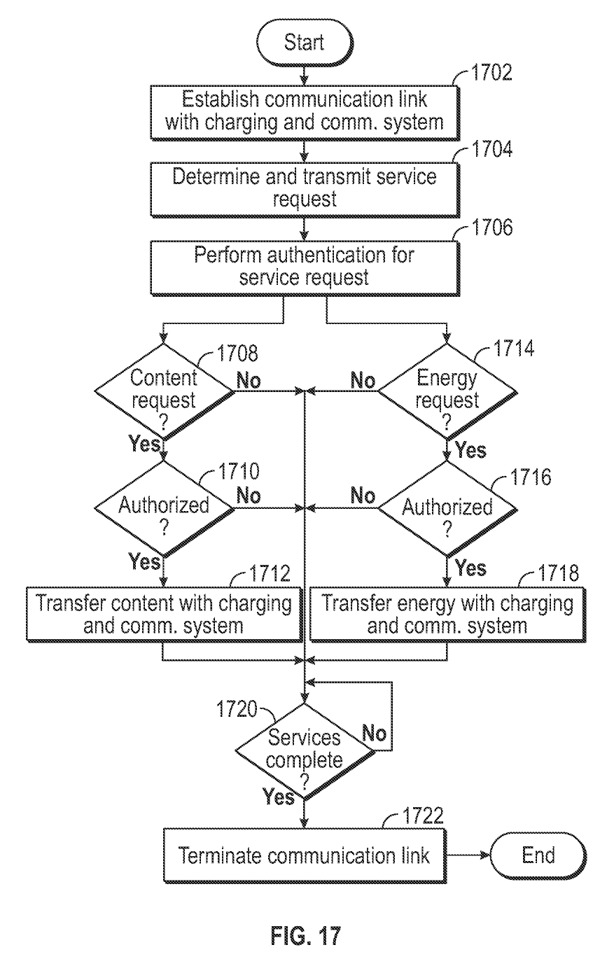

FIG. 17 shows a flowchart for an exemplary method performed by the vehicle charging and communication system 414 of wirelessly transferring at least one of content and energy. The flowchart begins at block 1702 as the vehicle charging and communication system 414 establishes a communication link with the charging and communication system 402a. In some embodiments, the communication link corresponds to control link 404. However, it is also contemplated that the communication link may correspond to power link 802 or content link 806, or some combination of links 802, 804, and 806.

Accordingly, in some embodiments, vehicle charging and communication system 414 may establish the communication link with charging and communication system 402a by using first antenna 608. However, it is contemplated that vehicle charging and communication system 414 may establish the communication link with any combination of its power antenna 416, first antenna 610, and second antenna 406a, or with any other antenna (not shown).

In block 1704, the vehicle charging and communication system 414 may determine a service request and transmit it to the charging and communication system 402a over the communication link established in block 1702. In some embodiments, the vehicle charging and communication system 414 determines the service request, in part, based on data received from the on-board interface 504 of the electric vehicle 412. In some embodiments, the vehicle charging and communication system 414 may determine the service request in part by data stored in memory 414 of the vehicle charging and communication system 414.

In block 1706, the vehicle charging and communication system 414 may perform authentication for the service request in block 1703 by using authenticator 416. Authentication may include the vehicle charging and communication system 414 generating authentication data that can used to establish the identity of (i.e., authenticate) vehicle charging and communication system 414 with the charging and communication system 402a. In that case, vehicle charging and communication system 414 may then transmit that authentication data over the communication link to charging and communication system 402a. Authentication may also include the vehicle charging and communication system 414 receiving authentication data from charging and communication system 402a or one or more of the content providers 648 over the communication link, and then determining authentication status of the sender based on the received authentication data. For example, vehicle charging and communication system 414 may use authenticator 716 to generate data corresponding to the expected authentication data to be received from charging and communication system 402a. Authentication status (i.e., whether the charging and communication system 402a passes or fails authentication) may be determined by comparing the received authentication data with data representing the expected authentication data.

In block 1712, if the service request includes a content request (block 1708) and if the vehicle is authorized (block 1710 and further described in connection with block 808), the vehicle charging and communication system 414 may transfer content with charging and communication system 402a. In that case, first or second transceiver 708 and 712 may receive or transmit content via first or second antenna 710 and 718. In some situations, vehicle charging and communication system 414 transfers content with charging and communication system 402a. In some situations, vehicle charging and communication system 414 transfers content with a content provider 648.

To facilitate efficient communication, first or second transceiver 708 or 712 may store data related to content and to the transfer of the content (e.g., control messages) by using memory 414. For example, memory 414 may be used as a data buffer for received and transmitted data. However, as stated memory 416 may also be used for long-term data storage.

If the service request includes an energy request (block 1714) and if authentication passed (block 1716), in block 1718 the vehicle charging and communication system 414 may transfer energy with charging and communication system 402a. In that case, power converter 402 may receive or transmit energy via power antenna 416. As stated, in some embodiments, power antenna 416 of the vehicle charging and communication system 414 couples with the power antenna 404a of the charging and communication system. Coupling includes near field coupling as well as and far field coupling, and includes coupling via electric fields, magnetic fields, and electromagnetic fields.

In block 1720 the vehicle charging and communication system 414 may continue transferring content or energy according to the service request until the transfers are completed. Once complete, in block 1722 the vehicle charging and communication system 414 terminates the communication link established in block 1702.

After service requests have been completed (block 1720), vehicle charging and communication system 414 terminates its communication link with charging and communication system 402a, in a similar manner as what was described in connection with the charging and communication system 402a terminating its communication link in block 1722.

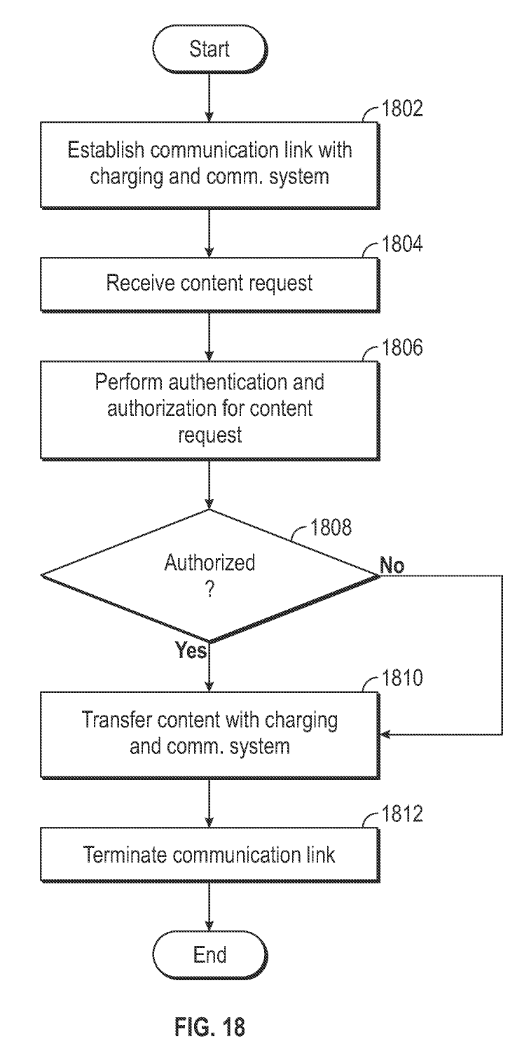

FIG. 18 shows a flowchart of an exemplary method of transferring content with a charging and communication system 402a. The flowchart begins at block 1802 as the content provider 648 establishes a communication link with a vehicle charging and communication system 414. The communication link may be established over network 614 and facilitated by server 618.

In block 1804, the content provider 648 receives a service request from charging and communication system 402a over the communication link established in block 1802. In some example embodiments, the service request comprises a request to transmit or receive content.

In block 1806, the content provider 648 may perform authentication for the service request in block 1804. Authentication may include authenticating the charging and communication system 402a based on authentication data received from charging and communication system 402a. Authentication may also include generating and sending authentication data to the charging and communication system 402a in order for the charging and communication system 402a to authenticate content provider 648.

In block 1808, the content provider 648 determines whether the charging and communication system 402a is authorized for its service request. If the charging and communication system 402a failed authentication, the charging and communication system 402a is not authorized and the content provider 648 may terminate communication. If the charging and communication system 402a passes authorization, the content provider 648 may query its accounts database (not shown) based on the authentication data (e.g., the authenticated user ID) to establish authorization status.

In block 1810 the content provider transfers content in accordance with the service request. Once complete, in block 1812 the content provider 648 system terminates the communication link established in block 1802.

Several benefits are provided by the various implementations contemplated by the present disclosure. In one aspect, various implementations allow for content stored by the electric vehicle 412 to be refreshed or updated with new content. For example, content may be refreshed/updated/synchronized automatically based on the user's accounts. Content may also be refreshed responsive to, e.g., a one-time transaction (e.g., purchasing a certain movie while the charging and communication system 402a wirelessly recharges the battery of the electrical vehicle 412). Further, it is also contemplated that the charging and communication system 402a may transfer content with personal devices communicably connected with the charging and communication system 402a. For example, a wireless device such as a smart phone may transfer data with the charging and communication system 402a while the electric vehicle 412 uses the charging and communication system 402a. Various embodiments allow for the electric vehicle 412 to automatically send content and other data related to the electric vehicle 412, users of the electric vehicle, and the activities associated with each. The benefit of receiving data from the electric vehicle 412 this data is that it allows charging stations (e.g., charging system 400) to collect data for marketing and advertising purposes as well as for tailoring the user's experience.

In one aspect, various implementations of the disclosed systems and methods allow for improved connectivity of a vehicle, particularly an electric vehicle 412, with a home computer network. Further, various implementations of the disclosed systems and methods allow for improved coordination of a fleet of vehicles. For example, a commercial entity in the business of delivering packages may connect its fleet of vehicles via an array of charging and communication systems like 402a in order to coordinate the shipment packages dynamically.

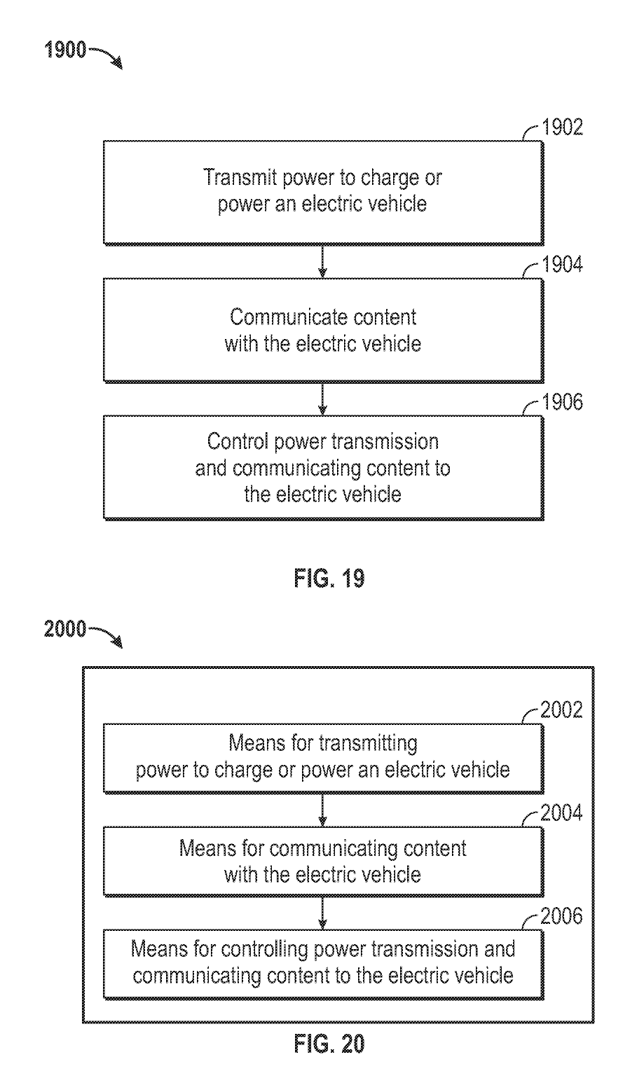

FIG. 19 shows a flowchart of an exemplary method implemented by a wireless power and communication apparatus. The method begins in block 1902 where a charging system transmits power to charge or power an electric vehicle 412. In block 1904, the charging system communicates content with the electric vehicle 412. In block 1906, the charging system controls power transmission and communicating content to the electric vehicle 412.

FIG. 20 illustrates a functional block diagram of a wireless power and communication apparatus. Device 2000 comprises means 2002, 2004, and 2006 for the various actions discussed with respect to FIGS. 1-18.

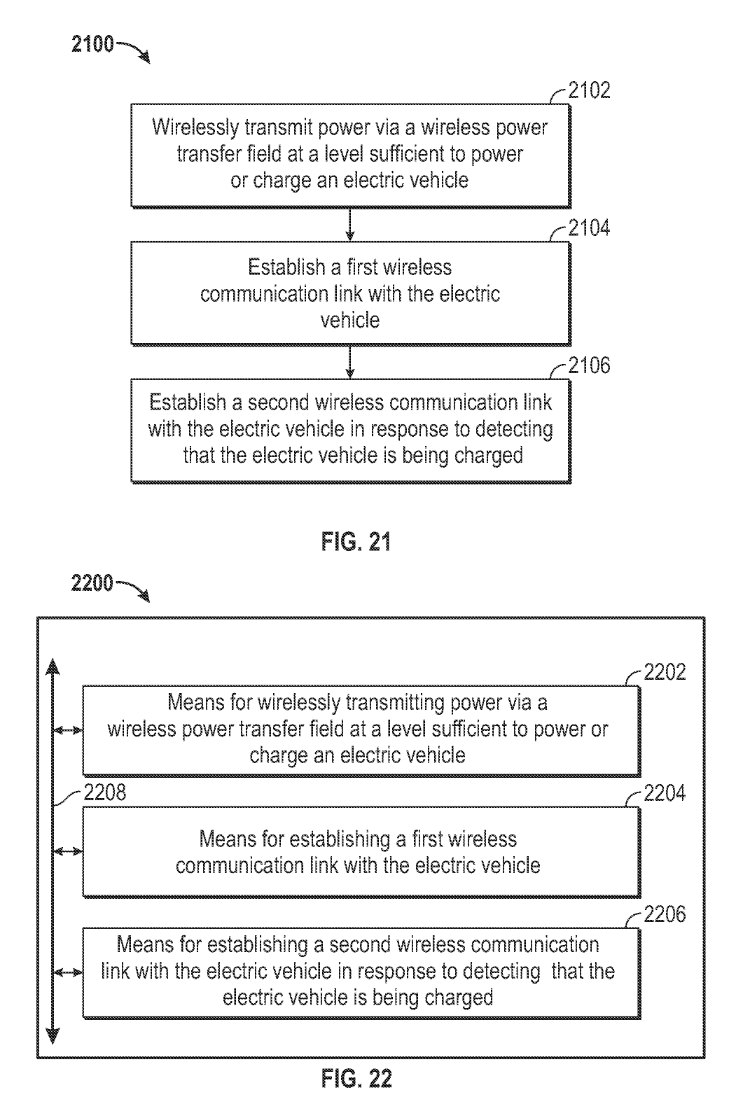

FIG. 21 is a flowchart of an exemplary method 2100 for wirelessly transferring power and communicating content with an electric vehicle 412. The method may be performed by a charging and communication system 402a (FIG. 8). The method begins at block 2102 where power is wirelessly transmitted via a wireless power transfer field at a level sufficient to power or charge an electric vehicle 412. For example, a charging and communication system 402a may wirelessly transmit the power via the power antenna 416. At block 2104 a first wireless communications link 804 is established with the electric vehicle 412. For example a controller 408 of a charging and communication system 402a may establish the first wireless communication link 804 using a first transceiver 606. At block 2106, a second wireless communication link 806 is established with the electric vehicle 412 in response to detecting that the electric vehicle 412 is being charged. For example, the controller 604 of the charging and communication system 402a may establish the second wireless communication link 806 using the second transceiver 610 in response to detecting the electric vehicle 412 is being charged. The first wireless communications link 804 may be a lower power communications link as compared to the second wireless communication link 806.

FIG. 22 illustrates another functional block diagram of a wireless power and communication apparatus 2200. Device 2200 comprises means 2202, 2204, and 2206 that may communicate via a communication system 2208 for the various actions discussed with respect to FIGS. 1-21.

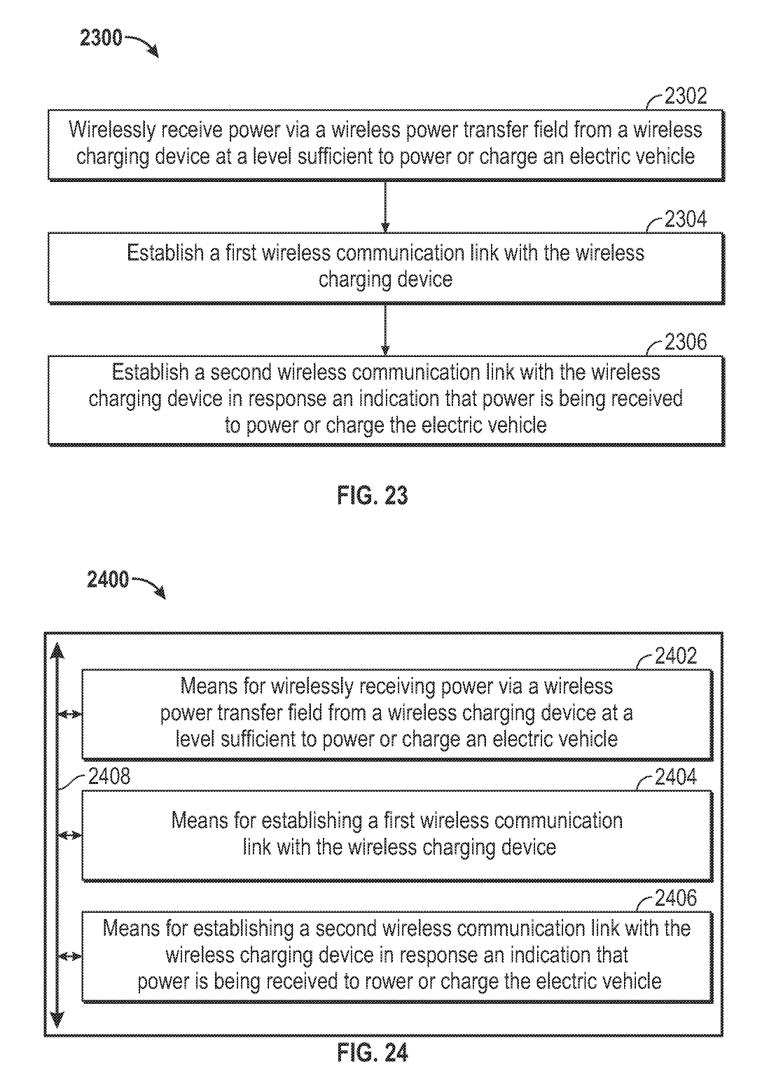

FIG. 23 is another flowchart of an exemplary method 2300 for wirelessly receiving power and communicating content from a charging and communication system 402a. The method may be performed by an electric vehicle 412 (FIG. 8). The method begins at block 2302 where power is wirelessly received via a wireless power transfer field from a wireless charging device (e.g., the charging and communication system 402a) at a level sufficient to power or charge an electric vehicle 412. For example, the electric vehicle 412 may wirelessly receive power from a charging and communication system 402a via the power antenna 416. At block 2304 a first wireless communications link 804 is established with the wireless charging device. For example a controller 706 of an electric vehicle 412 may establish the first wireless communication link 804 using a first transceiver 708. At block 2306, a second wireless communication link 806 is established with the wireless charging device in response to an indication that power is being received to power or charged the electric vehicle 412. For example, the controller 706 of the electric vehicle 412 may establish the second wireless communication link 806 using the second transceiver 712. The first wireless communications link 804 may be a lower power communications link as compared to the second wireless communication link 806.

FIG. 24 illustrates another functional block diagram of a wireless power and communication apparatus 2400. Device 2400 comprises means 2402, 2404, and 2406 that may communicate via a communication system 2408 for the various actions discussed with respect to FIGS. 1-23.

Although described separately, it is to be appreciated that functional blocks described with respect to FIGS. 1-23 need not be separate structural elements. For example, the functional blocks may be embodied on a single chip or within a single controller. Similarly, one or more of the functional blocks or portions of the functionality of various blocks may be embodied on a single chip or a single controller. Alternatively, the functionality of a particular block may be implemented on two or more chips.

One or more of the functional blocks and/or one or more combinations of the functional blocks may be embodied as a general purpose processor, a digital signal processor (DSP), an application specific integrated device, discrete gate or transistor logic, discrete hardware components, circuitry or any suitable combination thereof designed to perform the functions described herein. In this specification and the appended claims, it should be clear that the term “circuitry” is construed as a structural term and not as a functional term. For example, circuitry may be an aggregate of circuit components, such as a multiplicity of integrated circuit components, in the form of processing and/or memory cells, units, blocks, and the like, such as shown and described in FIGS. 1-12. One or more of the functional blocks and/or one or more combinations of the functional blocks described may also be implemented as a combination of computing devices, e.g., a combination of a DSP and a microprocessor, a plurality of microprocessors, one or more microprocessor in conjunction with a DSP communication, or any other such implementation.

Furthermore, it should be appreciated that content and control communication, including content transfer, may refer to a variety of types of data communication. For example, communication may include sending data packets or token packets. Furthermore communication may refer to other signaling and other packet types.

If implemented in software, the functions may be stored on or transmitted over as one or more instructions or code on a computer-readable medium. The steps of a method or algorithm disclosed herein may be implemented in a processor-executable software module that may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium that may be incorporated into a computer program product.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may include one or more elements.

A person/one having ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

A person/one having ordinary skill in the art would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, that may be designed using source coding or some other technique), various forms of program or design code incorporating instructions (that may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein and in connection with FIGS. 1-13 may be implemented within or performed by an integrated circuit (IC), an access terminal, or an access point. The IC may include a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. The logical blocks, modules, and circuits may include antennas and/or transceivers to communicate with various components within the network or within the device. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such implementation. The functionality of the modules may be implemented in some other manner as taught herein. The functionality described herein (e.g., with regard to one or more of the accompanying figures) may correspond in some aspects to similarly designated “means for” functionality in the appended claims.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Certain features that are described in this specification in the context of separate implementations also may be implemented in combination in a single implementation. Conversely, various features that are described in the context of a single implementation also may be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, other implementations are within the scope of the following claims. In some cases, the actions recited in the claims may be performed in a different order and still achieve desirable results.

What is claimed is:

1. A power transmission apparatus comprising:
a transmitter configured to wirelessly transmit power via a wireless power transfer field at a level sufficient to power or charge an electric vehicle; and
a controller circuit configured to:
establish a first wireless communication link with the electric vehicle; and
establish a second wireless communication link with the electric vehicle in response to detecting that the electric vehicle is being charged.

2. The apparatus of claim 1, wherein the controller circuit is configured to communicate via the first wireless communication link at a first power level, wherein the controller circuit is configured to communicate via the second wireless communication link at a second power level, wherein the first power level is less than the second power level.

3. The apparatus of claim 1, wherein the controller circuit is configured to communicate via the first wireless communication link over a first bandwidth, wherein the controller circuit is configured to communicate via the second wireless communication link over a second bandwidth, wherein the first bandwidth is less than the second bandwidth.

4. The apparatus of claim 1, wherein the controller circuit is configured to communicate with the electric vehicle via the first communication link via at least one of Bluetooth, Zigbee, UWB, wireless USB, DSRC, or the wireless power transfer field.

5. The apparatus of claim 1, wherein the controller circuit is configured to communicate, via the first communication link, information relating to at least one of detection of the electric vehicle, authentication of the electric vehicle, alignment of the electric vehicle over a coil of the transmitter, or a battery level of a battery of the electric vehicle.

6. The apparatus of claim 1, wherein the controller circuit is configured to communicate with the electric vehicle via the first communication link before the electric vehicle is being charged.

7. The apparatus of claim 1, wherein the controller circuit is configured to communicate with the electric vehicle via the second communication link via at least one of Wi-Fi, WiMax, UMTS, LTE, HSPA, GPRS, Flash-OFDM, EV-DO, EDGE, or RTT.

8. The apparatus of claim 1, wherein the controller circuit is configured to communicate, via the second communication link, information relating to at least one of charging control parameters, wireless power system capabilities, billing, metering, data for an onboard navigation system, electric vehicle maintenance, electric vehicle system updates, electric vehicle system monitoring, battery management, or multimedia content.

9. The apparatus of claim 1, wherein the controller circuit is configured to communicate data relating to charging via the first wireless communication link and configured to communicate content via the second wireless communication link.

10. The apparatus of claim 1, wherein the controller circuit is configured to establish the second communication link based on a receiver of the electric vehicle being powered at least partially based on the wirelessly transmitted power.

11. The apparatus of claim 1, wherein the controller circuit is configured to terminate the first communication link after establishing the second wireless communication link with the electric vehicle.

12. The apparatus of claim 1, wherein the controller circuit is configured to synchronize content stored in the electric vehicle with content stored on a network via the second communication link.

13. The apparatus of claim 1, wherein the transmitter comprises an antenna circuit having a resonant frequency, and wherein the transmitter is configured to drive the antenna circuit with a signal substantially equal to the resonant frequency.

14. A method of wireless power transmission, comprising:
wirelessly transmitting power via a wireless power transfer field at a level sufficient to power or charge an electric vehicle;
establishing a first wireless communication link with the electric vehicle; and
establishing a second wireless communication link with the electric vehicle in response to detecting that the electric vehicle is being charged.

15. The method of claim 14, further comprising communicating via the first wireless communication link at a first power level and communicating via the second wireless communication link at a second power level, wherein the first power level is less than the second power level.

16. The method of claim 14, further comprising communicating via the first wireless communication link over a first bandwidth and communicating via the second wireless communication link over a second bandwidth, wherein the first bandwidth is less than the second bandwidth.

17. The method of claim 14, further comprising communicating with the electric vehicle via the first communication link via at least one of Bluetooth, Zigbee, UWB, wireless USB, DSRC, or the wireless power transfer field.

18. The method of claim 14, further comprising communicating, via the first communication link, information relating to at least one of detection of the electric vehicle, authentication of the electric vehicle, alignment of the electric vehicle over a coil of the transmitter, or a battery level of a battery of the electric vehicle.

19. The method of claim 14, further comprising communicating with the electric vehicle via the first communication link before the electric vehicle is being charged.

20. The method of claim 14, further comprising communicating with the electric vehicle via the second communication link via at least one of Wi-Fi, WiMax, UMTS, LTE, HSPA, GPRS, Flash-OFDM, EV-DO, EDGE, or RTT.

21. The method of claim 14, further comprising communicating, via the second communication link, information relating to at least one of charging control parameters, wireless power system capabilities, billing, metering, data for an onboard navigation system, electric vehicle maintenance, electric vehicle system updates, electric vehicle system monitoring, battery management, or multimedia content.

22. The method of claim 14, further comprising communicating data relating to charging via the first wireless communication link and communicating content via the second wireless communication link.

23. The method of claim 14, wherein establishing the second communication link with the electric vehicle comprises establishing the second communication link based on a receiver of the electric vehicle being powered at least partially based on the wirelessly transmitted power.

24. The method of claim 14, further comprising terminating the first communication link after establishing the second wireless communication link with the electric vehicle.

25. The method of claim 14, further comprising synchronizing content stored in the electric vehicle with content stored on a network via the second communication link.

26. The method of claim 14, wherein wirelessly transmitting power comprises wirelessly transmitting power via an antenna circuit having a resonant frequency, and wherein the method further comprises driving the antenna circuit with a signal substantially equal to the resonant frequency.

27. A power transmission apparatus comprising:
means for wirelessly transmitting power via a wireless power transfer field at a level sufficient to power or charge an electric vehicle;
means for establishing a first wireless communication link with the electric vehicle; and
means for establishing a second wireless communication link with the electric vehicle in response to detecting that the electric vehicle is being charged.

28. The apparatus of claim 27, further comprising means for communicating via the first wireless communication link at a first power level and means for communicating via the second wireless communication link at a second power level, wherein the first power level is less than the second power level.

29. The apparatus of claim 27, further comprising means for communicating via the first wireless communication link over a first bandwidth and means for communicating via the second wireless communication link over a second bandwidth, wherein the first bandwidth is less than the second bandwidth.

30. The apparatus of claim 27, further comprising means for communicating, via the first communication link, information relating to at least one of detection of the electric vehicle, authentication of the electric vehicle, alignment of the electric vehicle over a coil of the transmitter, or a battery level of a battery of the electric vehicle.

31. The apparatus of claim 27, further comprising means for communicating, via the second communication link, information relating to at least one of charging control parameters, system capabilities, billing, metering, data for an onboard navigation system, electric vehicle maintenance, electric vehicle system updates, electric vehicle system monitoring, battery management, or multimedia content.

32. An apparatus for wirelessly receiving power, comprising:
a receiver configured to wirelessly receive power via a wireless power transfer field from a wireless charging device and to power or charge an electric vehicle based on the wirelessly received power; and
a controller circuit configured to:
establish a first wireless communication link with the wireless charging device; and
establish a second wireless communication link with the wireless charging device in response an indication that the receiver has started to power or charge the electric vehicle.

33. The apparatus of claim 32, wherein the controller circuit is configured to be powered based at least in part on the wirelessly received power to establish and communicate via the second wireless communication link.

34. The apparatus of claim 33, wherein the controller circuit is configured to be powered via a battery of the electric vehicle to establish and communicate via the second wireless communication link before the receiver powers or charges the electric vehicle.
